(19) United States
(12) Patent Application Publication
(10) Pub. No.: US 2024/0221719 A1
(43) Pub. Date: Jul. 4, 2024

(54) SYSTEMS AND METHODS FOR PROVIDING LOW LATENCY USER FEEDBACK ASSOCIATED WITH A USER SPEAKING SILENTLY

(71) Applicant: Wispr AI, Inc., South San Francisco, CA (US)

(72) Inventors: Tanay Kothari, San Francisco, CA (US); Anthony Leonardo, Broadlands, VA (US); Sahaj Garg, Foster City, CA (US)

(73) Assignee: Wispr AI, Inc., South San Francisco, CA (US)

(21) Appl. No.: 18/526,730

(22) Filed: Dec. 1, 2023

Related U.S. Application Data
(60) Provisional application No. 63/437,088, filed on Jan. 4, 2023.

(51) Int. Cl. G10L 13/027; G10L 13/033; G10L 13/047; G10L 15/25; G10L 25/18

(52) U.S. Cl. CPC G10L 13/027; G10L 13/033; G10L 13/047; G10L 15/25; G10L 25/18

(57) ABSTRACT

Methods and systems are provided for facilitating silent calling over a communication network. Such silent calling may be facilitated using a speech system associated with a first user configured to measure signals associated with the first user's speech muscle activation patterns and a communication interface configured to communicate with a communication device associated with a second user on the communication network. The first user's silent speech may be synthesized based at least in part on the signals associated with the first user's speech muscle activation patterns.

### CROSS-REFERENCE TO RELATED APPLICATIONS

This application claims the benefit under 35 U.S.C. § 119(e) of U.S. Provisional Application No. 63/437,088, entitled “SYSTEM AND METHOD FOR SILENT SPEECH DECODING,” filed Jan. 4, 2023, the entire contents of which are incorporated herein by reference.

### BACKGROUND

There are many existing systems for interacting with computer-based systems using speech captured from a user, as well as other input modalities through devices such as keyboards, mice, and other devices.

### SUMMARY

A communication system may employ silent speech that allows a user to speak silently. In such communication system, signals, such as electromyography (EMG) signals, may be captured to measure the user's speech muscle activation patterns when the user is speaking silently. Then, the measured signals (e.g., EMG signals) are recognized and converted to text transcribing the user's speech. However, users often do not immediately know or receive any feedback as to whether the system has correctly recognized the user's silent speech. For example, when the text transcribing the user's speech is generated and displayed on an output device, a significant time has already lapsed since the user has spoken the word(s). As such, no real-time feedback is provided to the user concerning the user's speech.

A communication system, such as cellular-based communication system or IP-based communication system, enables a user to make a call at any desired location of the user, whether in a private or public place. When making a phone call in a public place, technologies such as noise cancellation are provided to dampen the ambient noise that the user could hear. Noise cancelling technologies, however, may be effective only on certain noise such as lower frequencies of sound. Further, existing technologies do not solve other issues associated with making a call in a public place, such as anti-social behaviors that may be caused by speaking loudly in the public (e.g., speaking loudly in a public place simply is not pleasant to the people around the caller) or inability of keeping the call confidential, unless the user walks away from the public site.

According to one aspect, a system for synthesizing input speech of a user is provided. The system comprises a speech system configured to detect speech muscle activation patterns of the user when the user is speaking, a machine learning model configured to synthesize an audio signal of the input speech of the user using the signal indicative of the speech muscle activation patterns of the user, and a processor configured to output the synthesized audio signal of the input speech substantially in parallel in time with the user speaking.

According to one embodiment, synthesizing the audio signal of the user's input speech comprises inputting the signal indicative of the speech muscle activation patterns of the user to the machine learning model to generate a representation of the audio signal of the user's input speech and synthesizing the audio signal of the user's input speech using the representation of the audio signal. In one embodiment, the representation of the audio signal comprises a spectrogram of the user's input speech.

According to one embodiment, the speech system is a wearable device including an electromyography (EMG) sensor, whereby the signal indicative of the user's speech muscle activation patterns when the user is speaking comprises EMG data received from the EMG sensor when the user is speaking. In one embodiment, the machine learning model is a first machine learning model and the system further comprises a second machine learning model and synthesizing the audio signal of the user's input speech comprises using the first machine learning model to convert the EMG data to a spectrogram and using the second machine learning model to convert the spectrogram to the audio signal of the input speech of the user. In another embodiment, the system further comprises a vocoder implementing an algorithm and synthesizing the audio signal of the user's input speech comprises using the machine learning model to convert the EMG data to a spectrogram and using the vocoder implementing an algorithm to convert the spectrogram to the audio signal representing the speech of the user. In one embodiment the algorithm implemented by the vocoder is a Griffin-Lim algorithm. In one embodiment the machine learning model is trained to synthesize the audio signal of the user's input speech from the EMG data in one of a plurality of voices. In one embodiment, a first voice option of the plurality of voices comprises speech mimicking how the user should hear the user's own voice. In one embodiment, the processor is further configured to change one or more attributes of the first voice option. In one embodiment, the EMG sensor is configured to measure the EMG data when the user is speaking silently.

According to one embodiment, outputting the audio signal of the user's input speech substantially in parallel in time with the user speaking comprises playing back the audio signal of the user's input speech at a time that has elapsed from when the signal indicative of the user's speech muscle activation patterns were measured. In one embodiment, time that has elapsed is less than 200 ms. In one embodiment, the time that has elapsed is less than 50 ms. In one embodiment, the time that has elapsed is a period between when the user's speech muscle activation patterns are produced and when a sound would be produced if the user were to speak out loud. In one embodiment, the audio signal of the user's input speech is a first audio signal and the signal indicative of the user's speech muscle activation patterns is a first signal, the processor is further configured to receive a second audio signal and a second signal indicative of the user's speech muscle activation patters indicative of the user speaking a correcting word following the playback of the first audio signal, and the machine learning model is further configured to receive as input the second audio signal and the second signal indicative of the user's speech muscle activation patterns of the user to calibrate the machine learning model based on the correcting word.

According to one embodiment, the processor is further configured to detect a pause in the user's speech and play back the audio signal in response to detecting the pause in the user's speech.

According to one embodiment, the processor is configured to output the synthesized audio signal to a receiving device configured to playback the synthesized audio signal.

According to one aspect, a method for synthesizing a user's input speech is provided. The method includes measuring a signal indicative of the user's speech muscle activation patterns with a speech system, synthesizing an audio signal of the user's input speech using the signal indicative of the user's speech muscle activation patterns with a machine learning model, and outputting the synthesized audio signal of the user's input speech substantially in parallel in time with the user speaking using a processor.

According to one aspect, a non-transitory computer readable medium containing program instructions that, when executed, cause a system to perform a method is provided. The program instructions, when executed, cause a speech system to measure a signal indicative of the user's speech muscle activation patterns when the user is speaking, a machine learning model to synthesize an audio signal of the user's input speech using the signal indicative of the user's speech muscle activation patterns, and a processor to output the synthesized audio signal of the user's input speech substantially in parallel in time with the user speaking.

According to one aspect, a communication system for making and receiving a call is provided. The system comprises a speech system associated with a first user and configured to measure a signal indicative of speech muscle activation patterns of the first user when the first user is speaking, a communication interface configured to communicate with a communication device associated with a second user on a communication network, and one or more processors configured to determine speech data representing speech of the first user based on the signal indicative of the speech muscle activation patterns of the first user when the first user is speaking silently, transmit the speech data representing the speech of the first user to the communication device associated with the second user on the communication network using the communication interface, receive speech data representing speech of a second user from the communication device associated with the second user on the communication network using the communication interface, and output audio of the speech of the second user based on the received speech data representing the speech of the second user.

According to one embodiment, the speech system is a wearable device comprising an electromyography (EMG) sensor, whereby the signal indicative of the first user's speech muscle activation patterns when the first user is speaking silently comprises EMG data received from the EMG sensor when the first user is speaking silently. According to one embodiment, the speech data representing the first user's speech comprises a spectrogram or audio of the first user's speech, and the one or more processors are further configured to use a machine learning model to convert the EMG data to the spectrogram or audio of the first user's speech. According to one embodiment, the one or more processors are further configured to use the machine learning model to convert the EMG data to the spectrogram or audio of the first user's speech in a selected one of a plurality of voices responsive to receiving a user selection indicating the selected one of the plurality of voices. According to one embodiment, converting the EMG data to the audio of the first user's speech comprises using a first portion of the machine learning model to convert the EMG data to the spectrogram, and using a second portion of the machine learning model to convert the spectrogram to the audio of the first user's speech. According to one embodiment, the communication network comprises one or more computing devices configured to process the EMG data associated with the first user to generate a spectrogram or audio of the first user's speech for receiving by the communication device associated with the second user. According to one embodiment, the machine learning model is trained to generate the spectrogram or audio of the first user's speech in one of a plurality of voices. According to one embodiment, the speech data representing the first user's speech comprises a spectrogram of the first user's speech when the first user is speaking silently and the one or more processors are configured to convert the EMG data to the spectrogram. According to one embodiment, the communication network includes one or more computing devices configured to process the spectrogram of the first user's speech to generate an auditory signal of the first user's speech for receiving by the communication device associated with the second user from the communication network.

According to one embodiment, the received speech data from the communication network representing the second user's speech comprises audio of the second user. According to one embodiment, the received speech data from the communication network representing the second user's speech comprises EMG data or spectrogram data associated with the second user's speech and the one or more processors are further configured to use a machine learning model to convert the EMG data or spectrogram data to the audio of the second user's speech. According to one embodiment, the machine learning model is trained to generate the audio of the second user's speech in a selected one of a plurality of voices. According to one embodiment, the received speech data from the communication network representing the second user's speech comprises the spectrogram data of the second user's speech and the one or more processors are further configured to use a machine learning model to convert the spectrogram data to the audio of the second user's speech.

According to one embodiment, the speech data representing the first user's speech comprises audio of the first user's speech and transmitting the speech data representing the first user's speech to the communication device associated with the second user on the communication network is performed using a text protocol. According to one embodiment, the one or more processors are further configured to use a machine learning model and the signal indicative of the first user's speech muscle activation patterns when the first user is speaking silently as input to the machine learning model to generate the audio of the speech data representing the first user's speech. According to one embodiment, the speech data representing the second user's speech comprises text transcribing the second user's speech, and the one or more processors are further configured to output the speech data representing the second user's speech by displaying the text transcribing the second user's speech on a display. According to one embodiment, the display is installed on an electronic portable device, a smartphone, or augmented reality (AR) glasses. According to one embodiment, displaying the text transcribing the second user's speech comprises displaying a summary of the text transcribing the second user's speech. According to one embodiment, displaying the text transcribing the second user's speech comprises displaying text transcribing the first user's speech and the second user's speech that has been spoken during a duration of the call.

According to one embodiment, the one or more processors are further configured to transmit graphical data associated with a character of the first user to the communication device associated with the second user on the communication network wherein the graphical data comprises an avatar, an animated avatar, an emoji, or an animated emoji associated with the first user. According to one embodiment, the communication system further comprises an image capturing device configured to capture one or more images of the first user's face while the first user is speaking silently and the one or more processors are further configured to generate the avatar or the animated avatar of the first user based on the one or more captured images of the first user's face.

According to one embodiment, the speech data representing the first user's speech comprises audio of the first user's speech and the one or more processors are further configured to generate the audio of the first user's speech based on the signal indicative of the first user's speech muscle activation patterns when the first user is speaking silently and automatically remove filler words in the audio of the first user's speech before transmitting the audio of the first user's speech to the communication device associated with the second user on the communication network.

According to one embodiment, the one or more processors are configured to accept a call from the second user before receiving the speech data representing the second user's speech from the communication device associated with the second user on the communication network using the communication interface, wherein accepting is performed in response to receiving a gesture or an utterance from the first user. According to one embodiment, the one or more processors are configured to receive data from the communication network indicating that the call from the second user is a silent call. According to one embodiment, the one or more processors are configured to receive the gesture or the utterance responsive to receiving the data indicating that the call from the second user is a silent call.

According to one embodiment, the speech system associated with the first user is further configured to receive an audio signal of the first user's speech when the first user is speaking and the one or more processors are further configured to determine the speech data representing the first user's speech by using a machine learning model to remove noise in the audio signal of the first user's speech based on the signal indicative of the first user's speech muscle activation patterns when the first user is speaking. According to one embodiment, the one or more processors are further configured to change on or more attributes of a voice of the speech data.

According to one embodiment, the speech data representing the first user's speech is first speech data representing the first user's speech, the communication interface is configured to communicate with the communication device associated with a second user on the communication network when the first user is on a first call and communicate with a communication device associated with a third user on the communication network when the first user is on a second call, and the one or more processors are further configured to determine second speech data of the first user's speech when the first user is speaking on the second call and transmit the second speech data to the communication device associated with the third user on the communication network using the communication interface. According to one embodiment, the speech system associated with the first user is further configured to receive an audio signal of the first user's speech when the first user is speaking, the signal indicative of the first user's speech muscle activation patterns is a first signal indicative of the speech muscle activation patterns first user, and the second speech data is determined at least in part based on a second signal indicative of the first user's speech muscle activation patterns when the first user is speaking or the audio signal of first user's speech when the first user is speaking.

According to one aspect, a method for making and receiving a call in a communication system is provided. The method includes, by one or more processors determining speech data representing the first user's speech based on a signal indicative of the first user's speech muscle activation patterns when the first user is speaking, transmitting the speech data representing the first user's speech to a communication device associated with a second user on a communication network using a communication interface, receiving speech data representing second user's speech from the communication device associated with the second user on the communication network using the communication interface, and outputting audio of the second user's speech based on the received speech data representing the second user's speech.

According to one aspect, a non-transitory computer readable medium containing program instructions that, when executed, cause a system to follow a method is provided. The program instructions, when executed cause one or more processors to determine speech data representing the first user's speech based on a signal indicative of a the first user's speech muscle activation patterns when the first user is speaking silently, transmit the speech data representing the first user's speech to a communication device associated with a second user on a communication network using a communication interface, receive speech data representing second user's speech from the communication device associated with the second user on the communication network using the communication interface, and output audio of the second user's speech based on the received speech data representing the second user's speech.

According to one aspect, a communication system is provided. The system comprises a speech system configured to measure a signal indicative of a user's speech muscle activation patterns when the user is speaking silently and one or more processors configured to generate a feedback signal concerning the user's speech based on the signal indicative of a user's speech muscle activation patterns when the user is speaking silently and output the feedback signal at least in part simultaneously with the user speaking, wherein the feedback signal comprises an auditory signal of the user's speech mimicking how the user should hear the user's own voice as if the user were speaking vocally.

According to one embodiment, generating the feedback signal comprises using a machine learning model and the signal indicative of the user's speech muscle activation patterns when the user is speaking as input to the machine learning model to generate the feedback signal. According to one embodiment, using the machine learning model to generate the feedback signal comprises using the machine learning model and the signal indicative of the user's speech muscle activation patterns as input to the machine learning model to generate a representation of the auditory signal, and synthesizing the auditory signal using the representation of the auditory signal. According to one embodiment, the machine learning model is trained to generate the auditory signal from the signal indicative of the user's speech muscle activation patterns as input to the machine learning model. According to one embodiment, the machine learning model is trained to further generate text transcribing the user's speech while the user is speaking silently. According to one embodiment, the one or more processors are further configured to provide the text transcribing the user's speech to an interaction system configured to receive the text as a prompt and take one or more actions based on the prompt.

According to one embodiment, the one or more processors are further configured to receive an audio signal and EMG data associated with the user speaking a correcting word following playing the feedback signal and calibrate the machine learning model based on the audio signal and the EMG data associated with the correcting word. According to one embodiment, the one or more processors are further configured to receive a user interaction indicating calibration of the communication system in response to the playing back of the feedback signal in the auditory form before receiving the audio signal and the EMG data associated with the user speaking the correcting word and use one or more sensors to capture the audio signal and the EMG data associated with the correcting word.

According to one embodiment, the signal indicative of the user's speech muscle activation patterns when the user is speaking silently comprises an EMG signal and outputting the feedback signal at least in part simultaneously with the user speaking comprises playing back the auditory signal at a time that has elapsed from when the EMG signal was measured, wherein the time that has elapse is less than 200 ms. According to one embodiment, the one or more processors are further configured to detect a pause in the user's speech and play back the auditory feedback signal representing the user's speech preceding the detected pause in response to detecting the pause.

According to one embodiment, the feedback signal comprises text transcribing the user's speech. According to one embodiment, the one or more processors are further configured to output the feedback signal by displaying the text transcribing the user's speech on a display at least in part simultaneously with the user speaking. According to one embodiment, displaying the text transcribing the user's speech comprises displaying a summary of the text transcribing the user's speech. According to one embodiment, the one or more processors are further configured to receive a user interaction through a user interface in response to displaying the text transcribing the user's speech, the user interaction indicating the user's speech is correctly recognized and, in response to receiving the user interaction, trigger one or more actions or generate a response based on the text transcribing the user's speech.

According to one embodiment, the feedback signal comprises a haptic signal indicating a response to the user's speech. According to one embodiment, the haptic feedback signal may be a simulated haptic signal created by sound.

According to one embodiment, the feedback signal further comprises a waveform signal and outputting the feedback signal further comprises displaying the waveform at least in part simultaneously with the user speaking, wherein the waveform indicates a first state of the communication system indicating a start of recognizing speech. According to one embodiment, the feedback signal further comprises additional graphical user interface elements indicating additional states of the communication system, wherein the additional states comprise a second state indicating that the communication system is currently generating a response to the user's speech and a third state indicating that one or more actions have been executed or a response has been generated responsive to the user's speech.

According to one aspect, a method for processing silent speech in a communication system is provided. The method comprises, by one or more processors, receiving a signal indicative of a user's speech muscle activation patterns when the user is speaking, receiving an audio signal of the user's speech when the user is speaking, using a machine learning model to process the audio signal of the user's speech, the processing comprising removing noise in the audio signal based on the signal indicative of the first user's speech muscle activation patterns when the first user is speaking, and transmitting the processed audio signal of the user's speech to the communication network using the communication interface.

According to one aspect, a non-transitory computer readable medium containing program instructions that, when executed, cause one or more processors to perform a method. The instructions cause the one or more processors to receive an signal indicative of a user's speech muscle activation patterns when the user is speaking, receive an audio signal of the user's speech when the user is speaking, use a machine learning model to process the audio signal of the user's speech, the processing comprising removing noise in the audio signal based on the signal indicative of the first user's speech muscle activation patterns when the first user is speaking, and transmit the processed audio signal of the user's speech to a communication network using a communication interface.

According to one aspect, a communication system is provided. The system comprises a speech system associated with a first user, the speech system configured to, when the first user is speaking, measure a signal indicative of a first user's speech muscle activation patterns when the first user is speaking on a first call with a second user and receive an audio signal of the first user's speech when the first user is speaking on a second call with a third user, a communication interface configured to communicate with a first communication device associated with the second user on a communication network in the first call and communicate with a second communication device associated with the third user on the communication network in the second call, and one or more processors configured to determine first speech data representing the first user's speech in the first call based on the signal indicative of the first user's speech muscle activation patterns when the first user is speaking silently on the first call, transmit the first speech data to the communication device associated with the second user on the communication network using the communication interface and determine second speech data representing the first user's speech in the second call based on the audio signal of the first user when the first user is speaking on the second call with the third user and transmit the second speech data to the communication device associated with the third user on the communication network using the communication interface.

According to one embodiment, the speech system comprises an EMG sensor configured to measure the signal indicative of the first user's speech muscle activation patterns when the first user is speaking on the first call and an audio sensor configured to receive the audio signal of the first user's speech when the user is speaking on the second call. According to one embodiment, the speech system is further configured to measure the signal indicative of a first user's speech muscle activation patterns when the first user is speaking silently or whispering on the first call with the second user and receive the audio signal of the first user's speech when the user is speaking loudly or whispering on the second call with the third user. According to one embodiment, the speech system is configured to measure additional signals indicative of the first user's speech muscle activation patterns when the user is speaking loudly or whispering on the second call with the third user. According to one embodiment, the speech system is configured to receive additional audio signals of the first user's speech when the user is whispering on the first call with the second user.

According to one embodiment, the one or more processors are configured to toggle between the first call and the second call responsive to receiving a user interaction indicative of a switch between the first call and the second call. According to one embodiment, the user interaction comprises one or more of a gesture, an utterance, a voice command, a silent speech command, or an activation of a user interface element.

According to one embodiment, the communication interface is configured to maintain a constant communication with the first communication device associated with the second user on the first call and activate and deactivate communication with the second communication device associated with the third user on the second call responsive to receiving a signal indicating a start and end of the second call. According to one embodiment, the one or more processors are configured to transmit the first speech data to the communication device associated with the second user on the communication network using the communication interface in response to receiving a user interaction indicative of a trigger.

According to one aspect, a method for making multiple calls in a communication system is provided. The method comprises, using a speech system associated with a first user, when the first user is talking, measuring a signal indicative of a first user's speech muscle activation patterns when the first user is speaking on a first call with a second user and receiving an audio signal of the first user's speech when the first user is speaking on a second call with a third user; using a communication interface, communicating with a first communication device associated with the second user on a communication network in the first call and communicating with a second communication device associated with the third user on the communication network in the second call; and, using one or more processors, determining first speech data representing the first user's speech in the first call based on the signal indicative of the first user's speech muscle activation patterns when the first user is speaking silently on the first call, transmitting the first speech data to the communication device associated with the second user on the communication network using the communication interface, determining second speech data representing the first user's speech in the second call based on the audio signal of the first user when the first user is speaking on the second call with the third user, and transmitting the second speech data to the communication device associated with the third user on the communication network using the communication interface.

According to one aspect, a non-transitory computer readable medium containing program instruction that, when executed, cause one or more processors to perform a method. The instructions cause the one or more processors to determine first speech data representing a first user's speech in a first call with a second user on a communication network based on a signal indicative of the first user's speech muscle activation patterns when the first user is speaking silently on the first call, transmit the first speech data to a communication device associated with the second user on the communication network, determine second speech data representing the first user's speech in a second call with a third user on the communication network based on an audio signal of the first user when the first user is speaking on the second call with the third user, and transmit the second speech data to the communication device associated with the third user on the communication network.

Still other aspects, examples, and advantages of these exemplary aspects and examples are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1A is a diagram of a communication system configured to provide user feedback associated with a user speaking silently, according to some embodiments.

FIG. 1B is a flow chart showing an exemplary computerized method for providing user feedback associated with a user speaking silently, according to some embodiments.

FIG. 2A is a flow chart showing an exemplary computerized method for synthesizing an auditory signal of a user's silent speech directly from an EMG signal, according to some embodiments.

FIG. 2B is a flow chart showing an exemplary computerized method for synthesizing an auditory signal of a user's silent speech from an EMG signal via intermediate representation of auditory signal, according to some embodiments.

FIG. 2C is a flow chart showing an exemplary computerized method for synthesizing an auditory signal of a user's silent speech from an EMG signal via text transcription, according to some embodiments.

FIG. 2D is a flow chart showing an exemplary computerized method for generating text transcription of a user's silent speech directly from an EMG signal, according to some embodiments.

FIG. 2E is a scheme diagram of a speech model configured to generate text transcribing the user's speech, according to some embodiments.

FIG. 2F is a scheme diagram of a speech model configured to generate text transcribing the user's speech in a segmented manner, according to some embodiments.

FIG. 3A shows the content of synthesized audio predictions of a user's silent speech per audio frame when there is no jitter, according to some embodiments.

FIG. 3B shows the content of synthesized audio predictions of a user's silent speech per audio frame when there is jitter, according to some embodiments.

FIG. 3C shows a buffering mechanism for outputting synthesized audio predictions of a user's silent speech per audio frame that reduces jitters at time T3 and T4 when latency occurs, according to some embodiments.

FIG. 3D is a flow chart showing an exemplary computerized method for generating predictions of auditory signal using a buffering mechanism, according to some embodiments.

FIG. 4 illustrates examples of user interface elements showing various states of a communication system, according to some embodiments.

FIG. 5 illustrates example configurations of a communication system with two communication devices associated with two users in a call and a communication network, according to some embodiments.

FIG. 6 is a flow chart showing an exemplary computerized method for generating and transmitting speech data representing a user speech in a silent call to a communication network, according to some embodiments.

FIG. 7 illustrates an example communication system that measures both the signal indicative of a user's speech muscle activation patterns and the audio signal when the user is speaking loudly, according to some embodiments.

FIG. 8 is a flow chart showing an exemplary computerized method for processing and transmitting audio signal of a user speech in a communication system, where the processing includes removing noise from the audio signal using a signal indicative of the user's speech muscle activation patterns when the user is speaking, according to some embodiments.

FIG. 9A illustrates example configurations of a communication system capable of handling two calls in a communication network, according to some embodiments.

FIG. 9B is a flow chart showing an exemplary computerized method for handling a foreground call and a background call in a communication system, according to some embodiments.

FIG. 11 shows an illustrative implementation of a computer system that may be used to perform any of the aspects of the techniques and embodiments disclosed herein, according to some embodiments.

### DETAILED DESCRIPTION

Existing silent speech systems use one or more sensors to capture signals that measure the user's speech muscle activation patterns when the user is speaking silently, then recognize the signals and generate text transcribing the user's speech. The text transcribing the user's speech is displayed on an output device to the user. These systems have several drawbacks. For example, existing systems do not provide real-time feedback to the user in terms of whether the system has correctly recognized the user's speech as the user is speaking. The text transcription of the user's speech is often delayed and do not synchronize with the user's speech. Further, practically, absent any auditory feedback from the system, it is difficult for the user to speak silently for a long time.

The inventors have recognized and appreciated that it would be advantageous to provide real-time or low-latency output to the user and others and auditory feedback to the user concerning the user's silent speech. The inventors have recognized and appreciated that when a user speaks loudly, the speech muscle articulation may lead the auditable sound from the speech by a time period, such as less than 200 ms. Silent speech may occur in a minimally articulated manner, with limited or no visible movement of speech articulation muscles. As such, the timing for producing a real-time or low-latency auditory feedback of a user's silent speech would be the lead time (e.g., 200 ms or less) after the movement of speech articulation muscles is detected, where the lead time is the time period that it would take the auditable sound to be produced from when the speech muscle articulation has occurred for vocalized speech. Furthermore, the inventors have recognized and appreciated that it would be advantageous to provide a good user experience if the auditory feedback includes an audio signal of the user's silent speech in the user's own voice such that the user hears how the user's speech should sound naturally as if the user were speaking loudly (except the user speaks silently).

Accordingly, the inventors have developed techniques for generating real-time or low-latency feedback concerning a user's silent speech. Described herein are various techniques, including systems, computerized methods, and non-transitory instructions, that measure a signal indicative of a user's speech muscle activation patterns when the user is speaking silently. In some embodiments, the system may include one or more EMG sensors configured to measure an EMG signal of the user's speech. The system may generate a feedback signal concerning the user's speech based on the EMG signal; and output the feedback signal at least in part simultaneously with the user speaking, wherein the feedback signal may comprise an auditory feedback signal that comprises an audio signal of the user's speech mimicking how the user should hear the user's own voice as if the user were speaking vocally.

In some embodiments, the feedback signal may include an audio signal of the user's speech. The system may use a machine learning model convert the EMG signal to the audio signal, where the machine learning model may be trained to generate the audio signal from the EMG signal. In some embodiments, the system may use a machine learning model to convert the EMG signal to a representation of the audio signal; and synthesize the audio signal using the representation of the auditory signal. For example, the representation of the audio signal may include a spectrogram of the user's speech. Synthesizing the audio signal from the spectrogram may use another machine learning model, or other algorithms, such as Griffin-Lim algorithm. As another example, the representation of the audio signal may be generated by a neural codec. The representation of the audio signal may then be a discrete audio code received as output from the neural codec. In other embodiments, the representation of the audio signal may include any suitable form and be generated by any suitable component.

In some embodiments, the system may output the auditory feedback signal at least in part simultaneously with the user speaking, at a time that has elapsed from when the EMG signal was measured, wherein the time that has elapsed may be less than 200 ms. In some embodiments, to avoid jitter in the auditory feedback signal, the system may use a buffering mechanism to store the predictions of multiple frames of the auditory feedback signal. In some embodiments, the system may playback the auditory feedback signal word by word as the user speaks silently. In some embodiments, the system may detect a pause in the user's speech and playback the auditory feedback signal responsive to detection of the pause.

In some embodiments, the system may generate text transcribing the user's speech while the user is speaking, and display the text to the user as a way of feedback. In some embodiments, the user's speech may include prompts to an interaction system. Responsive to receiving a user interaction indicating that the system has correctly recognized the user's speech, the system may provide the text transcribing the user's speech as input prompt to the interaction system to take one or more actions or to generate a response based on the prompt.

In some embodiments, based on the hearing the feedback signal, the user may determine that the system mis-heard a word. The user may make a user interaction (e.g., via user interface, a gesture) to initiate a calibration of the system. For example, following playing back the feedback signal, the system may receive an audio signal and EMG data associated with the user speaking a correcting word; and cause to calibrate the machine learning model based on the audio signal and the EMG data associated with the correcting word. It is apparent that providing the real-time or low-latency feedback has advantages that enable the user to identify the mis-recognized word/phrase as the system is playing back the recognized speech, and immediately provide the correcting word for calibration. In comparison, when the feedback is played back to the user with much delay such as in existing silent systems, it would require multiple operations for the user to identify mis-recognized word(s) and provide speech samples of correcting words.

In some embodiments, the feedback signal may include a haptic signal indicating a response to the user's speech, such as a start/end of recognizing the user's speech. The system may output the haptic signal (e.g., a vibration) on a haptics device (e.g., a vibration device).

In some embodiments, the feedback signal may include a waveform signal, and the system may display the waveform at least in part simultaneously with the user speaking. The waveform may indicate a first state of the communication system indicating a start of recognizing speech. In some embodiments, the feedback signal may also include additional graphical user interface elements that indicate additional states of the communication system. For example, the additional states may include a second state indicating that the communication system is currently generating a response to the user's speech and a third state indicating that one or more actions have been executed or a response has been generated responsive to the user's speech.

Making a call in a public place can be an unpleasant experience both for the caller and people surrounding the caller in the public place. For example, the call may be confidential, thus the user may not want people in the public place to hear the conversation. Speaking on a call in the public place may also create disturbance and unpleasant experience to the people nearby. It is apparent that existing communication systems do not provide a solution. To avoid such unpleasant experience, the user either should not make/pick up the call or should walk away from the public site to find a private place to make the call.

The inventors have appreciated and acknowledged that silent speech may be used to enable silent calling, where the system can recognize a user's silent speech by recognizing signals indicative of the user's speech muscle activation patterns associated with the user is speaking silently. Accordingly, the inventors have developed techniques for silent calling in which the user may speak silently in a call with another user, allowing the user to make calls in a public place without anyone else hearing the conversation. As a result, the unpleasant experiences as described above associated with making calls in a public place can be avoided.

Described herein are various techniques, including systems, computerized methods, and non-transitory instructions, that facilitate a call between a first user and a second user on a communication network where each user can speak silently or vocally. A communication system is provided that may include a respective speech system and a respective communication device associated with each user on a call. A call may be established over a communication path between the communication device associated with the first user and the communication device associated with the second user on the call, via a communication network. In some embodiments, the speech system associated with a first user on a call may be configured to measure a signal (e.g., EMG signal) indicative of the user's speech muscle activation patterns when the user is speaking silently. The communication device associated with the first user may generate speech data representing the user's speech based on the EMG signal and transmit the speech data to the communication device of a second user on the call. The communication device of the first user may also receive the speech data representing the second user on the call for playing back on the speech system of the first user.

In some embodiments, the speech system may include an EMG sensor to measure the EMG signal of a user's speech muscle activation patterns when the user is speaking silently or loudly. The speech system may also include an audio sensor (e.g., a microphone) configured to measure an audio signal of the user's speech when the user is speaking loudly or whispering. In some embodiments, the speech system may be a wearable device, such as a headset, AR glasses, a smart watch, a smartphone or other suitable device. In other words, the speech may include a speaker and/or a display for playing back the speech data of the other user on the call. In some embodiments, the communication device may be a computer, a laptop, an electronic portable device such as a smartphone, a smart watch, or any other suitable device. The communication device may include an audio output device (e.g., a speaker), and/or a display for playing back the speech data of the other user on the call.

The speech data representing the user's speech may include a spectrogram or an audio signal of the user's speech. In some embodiments, the speech data representing a user's speech may be generated on any suitable device along the communication path between the first user and the second user on the call. For example, the speech data may be generated at a communication device associated with a user and transmitted to the communication device of the other user on the call. In other examples, the speech data may be generated at a hop in the communication network and transmitted to the communication device associated with the other user on the call. In other examples, the EMG data of a user may be received at the communication device associated with the other user on the call, where the communication device associated with the other user may generate the speech data representing the user based on the EMG data of that user. The various types of speech data may be generated using one or more trained machine learning models.

In some embodiments, speech data representing a user's speech may be generated in a selected voice, such as the user's own voice. In such configuration, a user's silent speech may be converted to a representation (e.g., a spectrogram or an audio signal) in a voice that mimics the user's own voice, which is transmitted to and played back by the other user on the call as if the user were calling vocally (although the user was calling silently).

In some embodiments, the speech data representing a user's speech may include text transcribing the user's speech, where the text may be displayed on the display of the other user on the call (e.g., speech system or communication device associated with the other user). In some embodiments, a summary of text transcribing a user's speech may be displayed on the display of the other user on the call. In some embodiments, the system may display a history of conversation on the call as new text is being transcribed from the user's speech.

In some embodiments, the speech system and/or communication device associated with a user may receive a user interaction for controlling operations of a call. For example, the user interaction may indicate accepting/rejecting an incoming call, adding a new call, switching between two calls, muting a call, ending a call, and/or other suitable operations. The user interaction may include a command (e.g., an utterance or a word in the user's speech), a gesture (e.g., nodding or shaking head), activation/deactivation of a user interface element (e.g., click of a button, sliding a slider).

In some embodiments, the system may process the speech data of a user before the speech is played back on the device (e.g., speech system or communication device) associated with the other user on the call. For example, filler words in a user's speech may be detected and automatically removed before being played back on the other user's output device.

In some embodiments, the system may transmit additional information through the communication path between the users on a call. For example, the additional information may include graphical data (e.g., an avatar, an emoji) associated with a character of a first user and display on a device associated with the second user on the call. In some embodiments, the avatar of the first user may be generated based on one or more captured images of the face of the user. In some embodiments, the additional information may also include data indicating whether a user is calling silently and such additional information may be transmitted to the other user on the call. Responsive to receiving the data, the other user on the call may take an appropriate action associated with the call, such as entering into silent calling mode to maintain the confidentiality of the call (after learning that the first user is making a silent call).

Described herein are various techniques, including systems, computerized methods, and non-transitory instructions, that enables a user to speak loudly while capturing both audio signal and EMG signal of the user's speech using respective types of sensors. The system may use a machine learning model to process the audio signal of the user's speech, including removing noise in the audio signal based on the EMG signal. The system may transmit the processed audio signal of the user's speech to a communication network to facilitate various applications.

In some embodiments, the machine learning model may be trained with voice training data and EMG training data collected when training subjects are speaking loudly in a noise-free environment. The machine learning model may be trained further based on additional training data including the voice training data and EMG training data collected in the noise-free environment with added noise.

Alternatively, and/or additionally, the system may be configured to change one or more attributes of voice in the audio signal of the user's speech. For example, the system may change the intonation in the voice to a more confident voice. In some examples, the system may change the pitch of the voice to be more energetic. The various embodiments described herein may be applied to any communication system involving silent speech and/or silent calling as described above and further herein.

Described herein are various techniques, including systems, computerized methods, and non-transitory instructions, that facilitate multiple calls among users on a communication network where each user can speak silently or vocally. A communication system is provided that may be configured in a similar manner as the communication system described above except the communication system described herein can facilitate multiple calls. In some embodiments, the system may facilitate a first call between a first user and a second user and a second call between the first user and a third user simultaneously. Each caller on any of these calls may be associated with a respective speech system and communication device as described above. Each user on any of these calls may make a silent call or a vocalized call.

In some embodiments, on the first call, the first user may make a vocalized call, whereas the first user may make a silent call on the second call simultaneously. For example, the user may be on a regular call and at the same time on a silent call with an assistant. The user may speak silently with the assistant during the first call such that the conversation between the user and the assistant will not be heard by the other user on the regular call. In some embodiment, the system may toggle between the first call and the second call responsive to detecting a user interaction indicating a switch between the first call and the second call. For example, the user interaction may include one or more of: a gesture, an utterance, a voice command, a silent speech command, or an activation of a user interface element.

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

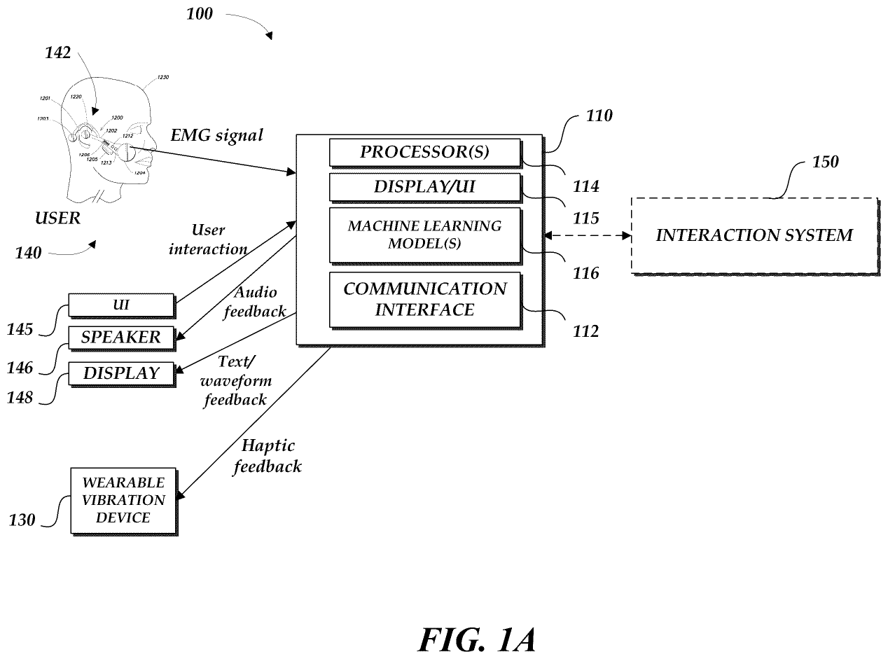

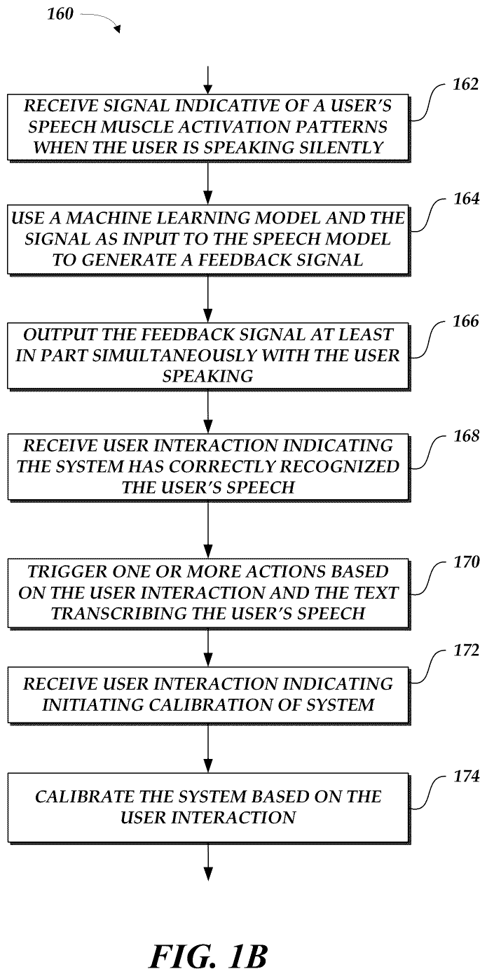

FIG. 1A is a diagram of a communication system 100 configured to provide user feedback associated with a user speaking silently, according to some embodiments. System 100 may include a speech system 140 and communication device 110, associated with a user, where the speech system 140 may be coupled to the communication device 110, wired or wirelessly (e.g., via Bluetooth). Communication system 100 may enable a user to speak silently and output a feedback signal concerning the user's speech at least in part simultaneously with the user speaking. In some embodiments, speech system 140 may include one or more sensors configured to measure a signal indicative of a user's speech muscle activation patterns (e.g., electromyography (EMG) signal) when the user is speaking silently. In some embodiments, the communication device 110 may generate a feedback signal concerning the user's speech based on the signal indicative of a user's speech muscle activation patterns (e.g., EMG signal) when the user is speaking silently; and output the feedback signal at least in part simultaneously with the user speaking.

In some embodiments, the feedback signal may include an auditory signal of the user's speech mimicking how the user should hear the user's own voice as if the user were speaking vocally. In some embodiments, the feedback signal may include other types of data such as text transcribing the user's speech, and haptic feedback. In some embodiments, the feedback signal may also include user interface element(s) indicating the state of the system responsive to the user's speech. Now, the communication system 100 is further described in detail.

With further reference to FIG. 1A, speech system 140 may include sensor(s) configured to measure a signal indicative of a user's speech muscle activation patterns when the user is speaking. For example, speech system 140 may include EMG sensor(s) configured to measure an EMG signal of the user's speech when the user is speaking (silently or loudly). In some embodiments, the speech system 140 may allow the user to speak silently or whisper and use the EMG sensor(s) to measure the EMG signal indicative of the user's speech muscle activation patterns when the user is speaking.

In some examples, silent speech may refer to unvoiced mode of phonation in which the vocal cords are abducted so that they do not vibrate, and no audible turbulence is created during the speech. Silent speech may occur at least in part while the user is inhaling, and/or exhaling. Silent speech may occur in a minimally articulated manner, for example, with visible movement of the speech articulator muscles, or with limited to no visible movement, even if some muscles such as the tongue are contracting. In a non-limiting example, silent speech may have a volume below a volume threshold (e.g., 30 dB when measured about 10 cm from the user's mouth). In some examples, whispered speech may refer to unvoiced mode of phonation in which the vocal cords are abducted so that they do not vibrate, where air passes between the arytenoid cartilages to create audible turbulence during the speech.

In some embodiments, the one or more sensors in speech system 140 may be configured to capture signals indicative of speech muscle activation patterns when the user is speaking. For example, the one or more sensors may include one or more EMG sensor(s) configured to measure the electromyographic activity signals of nerves which innervate muscles when the user is speaking. In some examples, the one or more sensors may include other types of sensors. For example, the one or more sensors may include audio sensor(s), e.g., a microphone, for capturing an audio signal when the user is speaking loudly. In some examples, the one or more sensors may include accelerometer(s) or inertial measurement unit(s) (IMU) configured to measure the movement of a body part of the user resulting from the speech muscle activation (e.g., facial muscle movement, neck muscle movement etc.) associated with the user speaking. In some examples, the one or more sensors may include optical sensor(s), e.g., photoplethysmography (PPG) sensor, which may be configured to measure the blood flow that occurs as a result of the speech muscle activation associated with the user speaking. In some examples, the one or more sensors may include ultrasound sensor(s) configured to generate signals that may be used to infer the position of a specific muscle, such as the tongue within the oral cavity associated with the user speaking. In some examples, the one or more sensors may include optical sensor(s) (e.g., a camera) configured to capture the visible movement of muscles on a body part of the user (e.g., a face, lips) associated with the user speaking. In some embodiments, speech system 140 may include a wearable speech device (e.g., 142) comprising at least an EMG sensor, whereby the signal indicative of the user's speech muscle activation patterns when the user is speaking silently comprises an EMG signal. Other additional sensor(s) may also be installed in the wearable speech device.

In some embodiments, speech system 140 may also include user interface 145 configured to receive user interactions(s) for controlling the communication system 100. For example, user interface 145 may detect user interaction(s), such as a user's gesture command, a user's speech command, and/or a control of a user interface element (e.g., a button, a slider, a touch pad). In some embodiments, speech system 140 may also include output devices such as speaker 146 and/or display 148, as described above and further herein. Speaker 146 and display 148 may be configured to receive data from the communication device 110, or from other components of speech system 140 for output. In some embodiments, speech system 140 may also include a haptics device 130, such as a wearable vibration device configured to output a vibration signal.

With further reference to FIG. 1A, communication device 110 may be coupled to the speech system 140 to receive the captured data from the user's speech (e.g., EMG data, audio signal) from the speech system when the user is speaking, and/or generate a feedback signal (e.g., audio, text) concerning the user's speech. Communication device 110 may include a communication interface 112 configured to communicate with the speech system 140 wired or wirelessly (e.g., via Bluetooth). For example, communication interface 112 may be configured to receive the sensor data (e.g., EMG data, audio data) captured from the speech system 110 when the user is speaking. Communication interface 112 may also be configured to receive other data from the speech system, such as user interaction(s) from user interface 145. In some embodiments, the communication interface 112 may be configured to provide the feedback signal concerning the user's speech to the speech system 110 for playback.

The feedback signal concerning the user's speech may be of various types. For example, the feedback signal may include an auditory signal that can be played back at speaker 146. In some examples, the feedback signal may include text transcribing the user's speech that can be displayed at display 148. In some examples, the feedback signal may include user interface element(s) (e.g., graphics) indicating a state of the system in response to the user's speech, where the user interface element(s) may be displayed at user interface, e.g., UI 145. In other examples, the feedback signal may include haptic feedback that may be output at a haptics device, e.g., wearable vibration device 130. In various embodiments, feedback signals may be output at any other suitable devices such as one or more components of communication device 110. Details of generating the feedback signal are further described with reference to FIGS. 1B-4.

FIG. 1B is a flow chart showing an exemplary computerized method 160 for providing user feedback associated with a user speaking silently, according to some embodiments. In some embodiments, method 160 may be implemented in communication system 100, e.g., communication device 110, speech system 140. Method 160 may start with receiving signal indicative of a user's speech muscle activation patterns when the user is speaking silently, at act 162; using a machine learning model and the signal as input to the machine learning model to generate a feedback signal, at act 164; and outputting the feedback signal at least in part simultaneously with the user speaking, at act 166.

In some embodiments, as described above and further herein, the acts 162-166 may be performed by communication device (e.g., 110 in FIG. 1A). For example, act 162 may be performed by the processor(s) 114 of communication device 110, which receives the signal indicative of the user's speech muscle activation patterns when the user is speaking silently. The signal indicative of the user's speech muscle activation patterns when the user is speaking silently may be an EMG signal or other types of signal measured at one or more EMG sensors such as what are provided in a speech system (e.g., 140) or other suitable sensors. The EMG signal may be transmitted, e.g., via a wireless communication such as Bluetooth, to the communication device 110. The communication device 110 may generate the feedback signal using one or more machine learning models 116 and the EMG signal received from the speech system. The feedback may be of various types as described above and further herein, and is provided to a suitable output device (e.g., an output device of the communication device 110, e.g., a display, a speaker, a haptics device; or any suitable output device of speech system 140). Depending on the type of feedback signal to be generated, various machine learning models may be trained to generate the feedback signal from the signal indicative of the user's speech muscle activation patterns (e.g., EMG data).

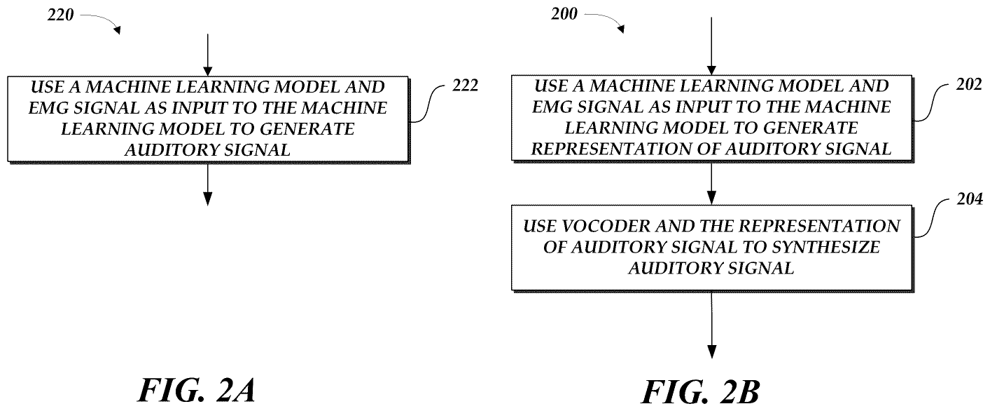

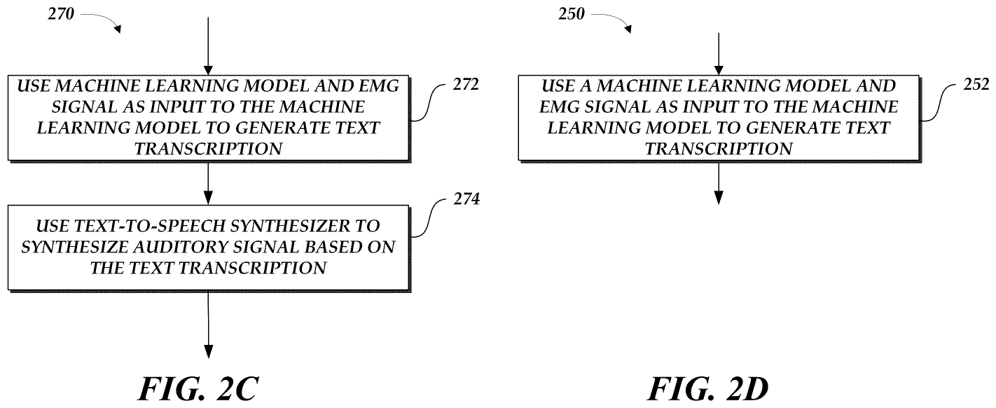

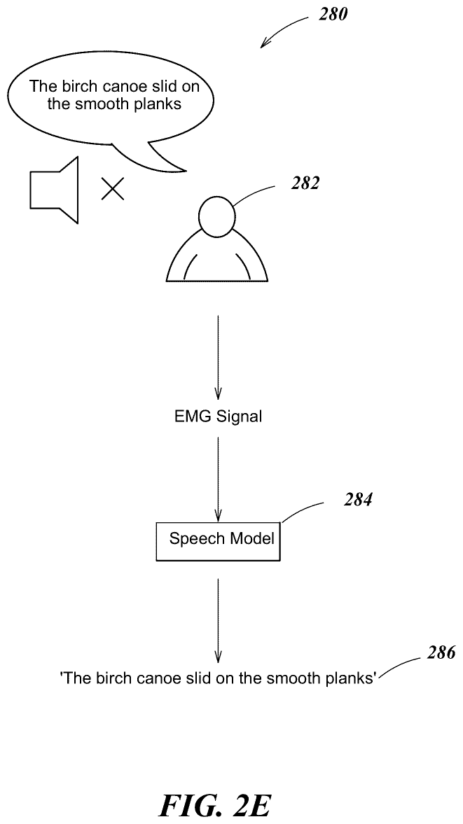

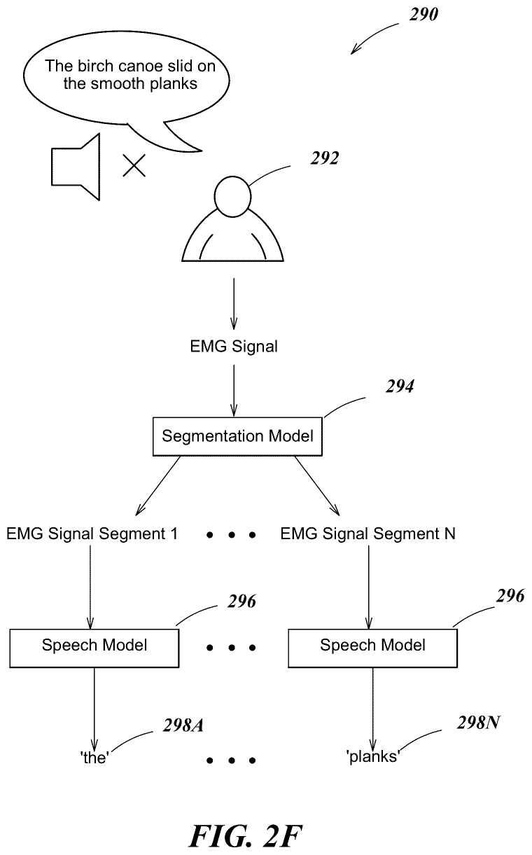

FIGS. 2A-2C show flow charts of various computerized methods for synthesizing an auditory signal of a user's silent speech from EMG signal. For example, FIG. 2A is a flow chart showing an exemplary computerized method 220 for synthesizing an auditory signal of a user's silent speech directly from an EMG signal, according to some embodiments. For example, method 220 includes using a machine learning model and the EMG signal as input to the machine learning model to directly generate the auditory signal of the user speech, at act 222.

FIG. 2B is a flow chart showing an exemplary computerized method 200 for synthesizing an auditory signal of a user's silent speech from an EMG signal via an intermediate representation of auditory signal, according to some embodiments. For example, method 200 includes using a machine learning model and the EMG signal as input to the machine learning model to generate a representation of auditory signal, at act 202. In some examples, the representation of auditory signal may include a spectrogram of the user's speech. Method 200 may proceed to use a vocoder to synthesize the auditory signal (speech) from the representation (e.g., spectrogram), at act 204. For example, the vocoder may use another machine learning model to convert the spectrogram data to audio speech. Alternatively, and/or additionally, the vocoder may use other algorithm(s), such as Griffin-Lim algorithm.

Comparing method 220 (FIG. 2A) to method 200 (FIG. 2B), method 220 may use a machine learning model trained and configured to predict an audio signal of the user speech directly from the EMG signal, without using any intermediate representation such as the spectrogram. In some embodiments, in training the machine learning model (for method 220), audio spectrograms may be used to determine an intermediate loss function.

FIG. 2C is a flow chart showing an exemplary computerized method 270 for synthesizing an auditory signal of a user's silent speech from an EMG signal via text transcription, according to some embodiments. For example, method 270 may include using a machine learning model and the EMG signal as input to the machine learning model to generate text transcribing the user's speech while the user is speaking silently, at act 272. Method 270 may proceed with using a text-to-speech synthesizer to synthesize the auditory signal based on the text transcription, at act 274.

In some embodiments, the auditory feedback signal may be in a generic voice. In some embodiments, the auditory feedback signal may be in a personalized voice that mimics the user's own voice. For example, the auditory feedback signal may be generated in the user's own voice and played back (e.g., at speaker 146 in FIG. 1A). Whereas the auditory feedback enables the user to confirm that the generated auditory feedback signal correctly recognized the user's speech, the auditory feedback signal in a personalized voice mimics a real environment in which the user listens to the auditory feedback as if the user were speaking loudly (although the user was speaking silently), simulating a real-life experience. In some embodiments, the communication system 100 may use the auditory feedback signal in the user's own voice as a voiceID and transmit the voiceID to an authentication system.

In some embodiments, the machine learning model(s), e.g., 116 used in methods 220, 200 (FIGS. 2A-2B), may be a general model trained across a plurality of training subjects (e.g., WaveNet). In other embodiments, in generating the auditory feedback signal in a personalized voice, the machine learning model(s) may be fine-tuned to a particular user's voice based on co-recorded EMG signals and vocal speech of the user, such that the trained machine learning model(s) may be used to generate user specific voice. In other embodiments, the machine learning model(s) may be trained to generate a type of voice (e.g., a female voice, a male voice, a voice of an age group, an adult voice, a child's voice, or any combination thereof). In some embodiments, the personalized voice may include different pitches in an auditory signal, where the various machine learning model(s) may be trained to generate an auditory signal with particular pitches that mimics a person's voice. The training data for training the machine learning model(s) may include co-recorded EMGs and vocal speech of users belonging to a particular group.

In some embodiments, the auditory signal may be played back on an audio output device, such as speaker 146 (FIG. 1A). The speaker can be of various types, including a bone conduction speaker that mimics the user experience as if the user were hearing his/her own speech when speaking vocally (although the user is speaking silently). In some embodiments, the speaker may be an in-ear earbud, an over-the-ear headphone, an open-ear speaker installed on a wearable device (e.g., wearable device 142 in FIG. 1A), an external speaker installed on an external electronic device (e.g., communication device 110).

In some embodiments, the timing for playing back the auditory feedback signal may be configured such that the audio of the auditory feedback signal mimics what the user would have heard his/her own voice while the user were speaking loudly, except that the user is speaking silently. Typically, when the user speaks (vocally), the time the EMG signal is measured (detected) precedes the user's voice by about 200 ms. As such, to mimic the user's own voice from silent speech, the auditory feedback signal may be configured to be played after approximately 200 ms or less (e.g., 200 ms, 100 ms, 50 ms, 40 ms etc.) has elapsed since the EMG signal (associated with the silent speech) is captured.

The inventors have recognized and appreciated that generating the auditory feedback signal and delivering the generated feedback signal at a fixed elapsed time after the EMG signal is captured may not be guaranteed even if the processor(s) are fast enough to process chunks of EMG signals before the target playback time (e.g., 200 ms or less). For example, limited network bandwidth between speech system 140 and communication device 110 or slow processing speed of the one or more processors in communication device 110 may have a negative impact on the availability of the predicted audio signal. This latency may result in jitter in the auditory feedback signal when played back.

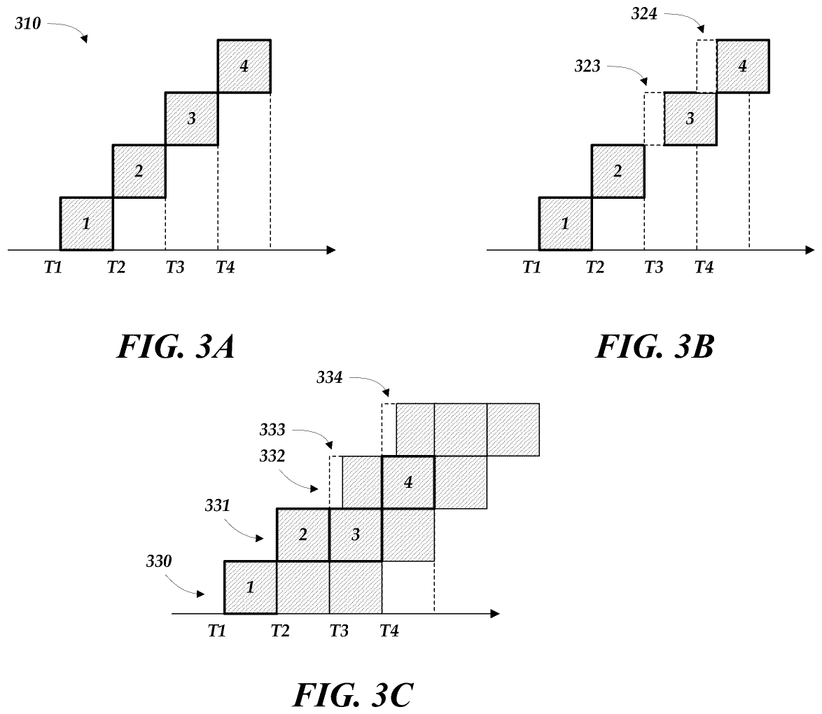

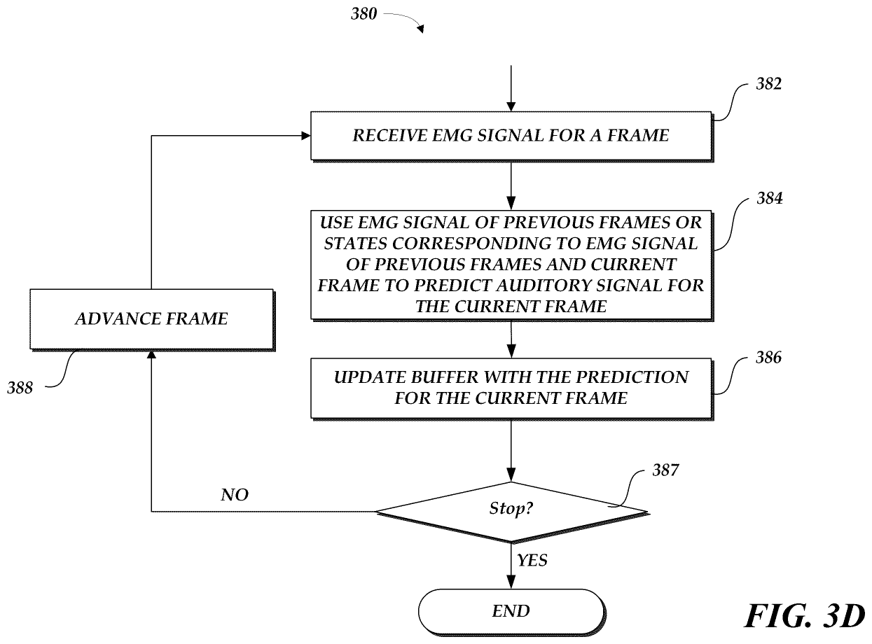

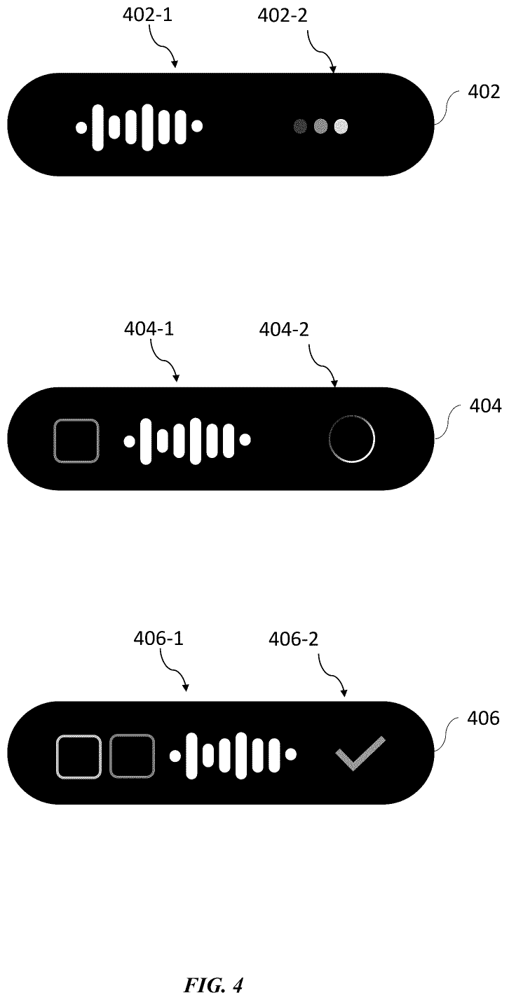

In non-limiting examples, FIG. 3A shows the content of synthesized audio predictions of a user's silent speech per audio frame when there is no jitter, according to some embodiments. FIG. 3A shows that new audio predictions (labelled in shaded boxes 1, 2, 3, 4 etc.) become available at every audio frame, e.g., every 10 ms at T1, T2, T3. When the audio predictions are generated fast enough, the contents (e.g., shaded boxes 1, 2, 3, 4) are sequentially played back at fixed time frames, such as T2, T2, T3, . . . , without jitter.

FIG. 3B shows the content of synthesized audio predictions of a user's silent speech per audio frame when there is jitter, according to some embodiments. At time T3, the arrival of the audio prediction for time frame T3 experiences a latency (see 323 shown in dashed box), for example, because of the latency in the network, slow processing, or other reasons. As a result, the auditory feedback signal will be played back with jitter. Similarly, there is also jitter at time T4 (see 324 shown in dashed box).

Accordingly, the inventors have developed techniques that use buffering mechanism to prevent jitter in the auditory feedback signal. FIG. 3C shows a buffering mechanism for outputting synthesized audio predictions of a user's silent speech per audio frame that reduces jitters at time T3 and T4 when latency occurs, according to some embodiments. The buffering mechanism shown in FIG. 3C may solve the jitter problem in FIG. 3B. As shown in FIG. 3C, for each time frame, a new audio prediction is generated and stored in a buffer. In this example, a buffer shown in a horizontal arrangement of shaded blocks stores a number of frames of audio predictions (e.g., three in this example). As new EMG data is measured, new audio predictions are generated and the buffer is updated with the new audio predictions. For example, at 330, a version of the buffer stores the predictions for audio frames T1, T2, T3. At time T1, the audio prediction in block 1 for time frame T1 is available, and is thus used to synthesize audio for playback. Responsive to capturing EMG data in a new frame, at 331, the buffer is updated to store the predictions for time frames T2, T3, and T4.

At time T2, the audio prediction in block 2 for time frame T2 is available, and is thus used to synthesize audio for playback. At time T3, latency (shown as 333) occurs where the first few milliseconds of the audio prediction for time frame T3 did not arrive, and thus, block 3 in the same version of the buffer 331 is used to synthesize the audio for playback at time frame T3. At time T4, latency 334 occurs. The most recent buffer update (332) stores the audio prediction for time frame T4 as block 4, which is used to synthesize audio for playback. The details of updating the buffer are described further with respect to FIG. 3D.

FIG. 3D is a flow chart showing an exemplary computerized method 380 for generating predictions of audio signals using a buffering mechanism, according to some embodiments. In some embodiments, method 380 may be implemented in a suitable device such as one or more processors 114 of communication device 110 (FIG. 1A). In some embodiments, method 380 may be implemented in speech system 140 (FIG. 1A). In some embodiments, buffering mechanism implemented in method 380 may store/update the audio predictions of multiple time frames in a buffer that is used synthesize for audio playback (e.g., as shown in FIG. 3C). For example, as each frame of an EMG signal (e.g., 10 ms per frame) is captured, the system may use the captured EMG signal and the user's speech prior to the time the EMG signal was captured, to predict the audio signal of the speech and store the audio prediction in the buffer. The system repeats the prediction steps for the next frame of the EMG signal.

In non-limiting examples, with reference to FIG. 3D, method 380 may start with receiving an EMG signal for a current frame (e.g., 10 ms), at act 382. For example, the EMG signal may be measured at speech system 140 (e.g., using EMG sensor(s)). Method 380 may proceed to act 384, using the EMG signal of previous frames (or states corresponding to the EMG signal of previous frames) and the EMG signal of the current frame to predict an audio signal. For example, machine learning model(s) 116 may be used to convert the EMG signal to the auditory feedback signal comprising an audio signal. In some embodiments, machine learning model(s) may be a recurrent network and may be configured to maintain states for a time period (e.g., transformer hidden states) and use these states and the EMG signal of the current frame to predict the audio signal. In some embodiments, the EMG signals prior to the time when the current EMG frame is captured may be stored in a buffer (e.g., buffer associated with EMG sensor(s)), and used to predict the audio signal of a later frame. In non-limiting examples, the buffer size may be 1 second to 5 seconds, 500 ms to 1 second, or of any other suitable values. In some embodiments, the previously recognized words may be stored in a buffer and used to predict the audio signal in a future time.

With further reference to FIG. 3D, method 380 may update the buffer with the audio prediction for the current frame, at act 386. For example, the system may sequentially fill in the buffer with predictions for consecutive frames. For example, previously the buffer contains predictions for frames f1, f2, f3. In updating the buffer, the buffer is filled with predictions for frames f2, f3, f4. In this update, the previous audio predictions for frames f2 and f3 have not been played yet, and thus are updated with new predictions. Additionally, the audio prediction for frame f4 is generated and stored. Method 380 may proceed with advancing a frame at act 388 and repeat acts 382-386 for the next frame, until one or more stop criteria are met, at act 387.

In some embodiments, the size of the buffer may be determined based on expected latency time, which can be calculated from previous runs of the predictions. For example, although the size of the buffer is illustrated in FIG. 3C to include three time frames (e.g., 30 ms), it is appreciated that the buffer can be of any other sizes, e.g., 40 ms, 50 ms, 60 ms, 70 ms, 80 ms, 90 ms, 100 ms, or any suitable size.

In some embodiments, instead of playing back the auditory feedback signal simultaneously with the user speaking, the system may play back a whole clip after the user finished speaking, or during a pause of the user's speech. For example, the system may detect a pause in the user's speech. Responsive to detecting the pause in the user's speech, the system may play back the auditory feedback signal representing the user's speech preceding the detected pause. In some embodiments, the system may detect a pause in the user's silent speech using training data that includes baseline EMG data with no audio or speech.

Returning to FIG. 1A, the feedback signal provided to speech system 140 may include text transcribing the user's speech, which may be displayed on display 148. FIG. 2D is a flow chart showing an exemplary computerized method 250 for generating text transcription of a user's silent speech directly from an EMG signal, according to some embodiments. For example, method 250 may include using a machine learning model and the EMG signal as input to the machine learning model to generate text transcribing the user's silent speech, at act 252. In some embodiments, the system may generate the auditory signal (e.g., as described in FIGS. 2A-2C) and the text transcribing the user's speech (e.g., as described in FIG. 2D) independently, or in combination. For example, any of the methods 200 (FIG. 2B), 220 (FIG. 2A), 270 (FIG. 2C) may be performed in parallel with method 250 (FIG. 2D). Alternatively, text transcribing the user's speech may be generated along with method 270 (e.g., act 272 in FIG. 2C), which also generates the auditory signal of the user's speech.

In some embodiments, the machine learning model of method 250 and/or of method 270 may be a speech model configured to decode speech to predict text or encoded features using EMG signals. In some embodiments, the speech model may be trained and installed on a communication system of any embodiment described herein. Alternatively, the speech model may be installed in an external device. When deployed, the speech model may be configured to receive the EMG signal indicative of the user's speech muscle activation patterns associated with the user's speech and use the EMG signal to generate a text transcribing the user's speech. It can be appreciated that the speech model can generate text transcribing the user's speech when the user is speaking either loudly or silently.

FIG. 2E is a scheme diagram of a speech model configured to generate text transcribing the user's speech, according to some embodiments. As shown in FIG. 2E, the user 282 speaks “The birch canoe slid on the smooth planks.” The speech model 284 receives the EMG signal associated with the user's speech, where the EMG signal indicates the speech muscle activation patterns as discussed above and further herein. The speech model 284 outputs the text 286 “The birch canoe slid on the smooth planks.”

In some embodiments, the speech model may be configured to generate text transcribing the user's speech using the EMG signal in a segmented manner. FIG. 2F is a scheme diagram of a speech model configured to generate text transcribing the user's speech in a segmented manner, according to some embodiments. As shown in FIG. 2F, the EMG signal may first be segmented by a segmentation model 294 before being received by the speech model 296. In the example shown, the EMG signal is segmented into a number of segments (e.g., 1, 2, . . . , N). The EMG signal segments are provided to the speech model 296 which is configured to output the text 298A-298N corresponding to each of the EMG signal segments. In some embodiments, the EMG signals are segmented by word, for example, the speech “The birch canoe slid on the smooth planks” is segmented by eight segments each corresponding to a respective word in the speech. As shown, the speech model 296 may output eight words each corresponding to a respective EMG signal segment. Although it is shown that segmentation model 294 segments the EMG signals by word, it is appreciated that the segmentation model may also be trained to segment the EMG signals in any other suitable manner, where each segment may correspond to a phoneme, a syllabus, a phrase, or any other suitable segment unit. Accordingly, the speech model 296 may be trained to predict text that corresponds to a signal segment (e.g., EMG signal segment), where a segment may correspond to a segmentation unit, e.g., a sentence, a phrase, a word, a syllable etc.

Returning to FIG. 1A, in some embodiments, the text transcribing the user's speech may be received at the speech system (e.g., 140) associated with the user and displayed at a display device of the speech system (e.g., display 148). For example, while the user is speaking silently, the user may view the transcribed text on the display, in lieu of, or in addition to hearing the auditory feedback signal. In some embodiments, the display may be installed on the speech system 140 (e.g., 148). For example, the display may be AR glasses or a headset such as a VR or mixed reality headset that can display the text feedback in an immersive way. In some embodiments, the display may be installed on communication device 110 (e.g., display/UI 115). For example, the communication device 110 may be a laptop, a smartphone, or any suitable electronic portable device. In other variations, the display may be a projector (e.g., a wearable projector), a wearable device with a display (e.g., a smart watch).

The text feedback may be displayed at least in part simultaneously with the user speaking, yet the system may allow the user to see the text feedback without closely reading it. For example, the AR glasses (e.g., 148) may enable the user to scroll the text in the display by raising up/down the user's head to skim through the text. In some embodiments, on a display of communication device 110, the user may scroll the text with a slide bar or other widgets in the user interface (e.g., 115).

In some embodiments, the text transcribing the user's speech may be displayed as each word in the user's speech is recognized. Alternatively, the text transcribing the user's speech may be displayed sentence by sentence. For example, the system may detect a pause in the user's speech as described above and further herein. In some embodiments, the system may detect that the user has finished a full sentence or a whole phrase, for example, based on analyzing the text being transcribed. Upon detecting the pause or determining that the user has finished a full sentence or a whole phrase, the system may send the text transcribed prior to the detection to the display for output, and continue transcribing incoming speech.

In some embodiments, the display (e.g., 148, 115) may be configured to display a summary of what the user said or some paraphrase of what the user said (e.g., an abbreviated version). In some embodiments, the summary or abbreviated version of what the user said may be generated by a large language model. For example, communication device 110 may transmit the text transcribing the user's speech to an interaction system (e.g., 150), which may employ a large language model to generate the summary or abbreviation of the text, which may be provided to the display (e.g., 146, 115). In non-limiting examples, the user says “archive the email.” In response, a paraphrase “archive this” may be displayed. In another example, the user says “Let Bob know . . . ” (followed by a long sentence). In response, “Let Bob know . . . ” followed a summary of the long sentence may be displayed.

In some embodiments, the communication system 100 may provide the text transcribing the user's speech to an interaction system (e.g., 150) configured to receive the text as a prompt and take one or more actions or generate responses based on the prompt. In non-limiting embodiments, an interaction system 150 may be coupled to the communication device 110 (e.g., via a wired or wireless communication network) to receive the text prompt (based on the user's speech). Based on the received text prompt, the interaction system 710 may take one or more actions, or generate a response and provide the response to the user through the communication device 110. For example, in response to the user's silent speech (e.g., a command), a response from the interaction system may be generated and provided to the speech system (e.g., 140) for output at an output device (e.g., speaker 146, display 148). Alternatively, and/or additionally, the interaction system may take one or more actions in response to the text prompt.

In some embodiments, when the feedback signal concerning the user's speech is provided to the user for playback (such as an audio signal being played back on speaker 146), the user may trust the system after hearing the synthesized audio of what the system has recognized, without requiring text transcriptions to be displayed to the user (no intermediate text is needed). For example, with reference to FIG. 1B, method 160 may include receiving user interaction indicating that the system has correctly recognized the speech, at act 168. Method 160 may proceed to act 170 by triggering one or more actions (e.g., via interaction system 150 in FIG. 1A) based on the user interaction and the text transcribing the user's speech, at act 170. For example, the text transcribing the user's speech may be provided to an interaction system (e.g., 150 in FIG. 1A) as a text prompt to cause the interaction system to take one or more actions. In some embodiments, the interaction system 150 may include a large language model to process the text prompt and take one or more actions or generate a response.

In some embodiments, the user interaction may include gesture/expression indicating to the system whether the system has recognized the speech correctly. Details of gesture/expression recognition are further provided herein with reference to FIG. 10. The user interaction may also be of other forms. For example, the user interaction may be provided by the user via user interface 145 (FIG. 1A). In some embodiments, user interface 145 may include button(s), slide bar(s), touch pad or other widgets which may enable the user to provide user interactions.

In some embodiments, based on the feedback signal, the user may determine that the system mis-heard what the user said (silently) and invoke the system to calibrate. For example, in response to the playback of the auditory feedback signal, the user may provide a user interaction to the system to calibrate. The user interaction may include various forms, such as a gesture/expression, as described in detail above and further herein. The user interaction may also be of other forms. For example, the user interaction may be provided by the user via a user interface (e.g., 145, 115), in a similar manner as described above. The calibration may be performed using both the EMG data and voice. For example, with reference to FIG. 1B, method 160 may further include receiving user interaction which responds to the feedback signal, at act 172, where the user interaction indicates initiating a calibration to the communication system. In response to receiving (and recognizing) the user interaction, method 160 may cause the system (e.g., speech system 140, communication device 110) to enter into a calibration mode, at act 174, in which the user may speak word(s) loudly.

In non-limiting examples, the user may speak one or more correcting words loudly to calibrate the system. A correcting word may repeat the same word that the system mis-heard. The correcting word may also be a different word. The system may use one or more sensors to capture the audio signal and the EMG signal associated with one or more correcting words to be used as training samples. In some embodiments, the system may receive a pairwise audio signal and EMG signal associated with the user speaking the correcting word(s); and calibrate based on the audio signal and the EMG data associated with the correcting word(s). For example, the machine learning model(s) 116 for converting EMG data to auditory feedback signals (or any representation of the auditory signal) may be fine-tuned (re-trained) using the pairwise audio signal and EMG signal (associated with correcting words).

In some embodiments, the system may be configured to continuously calibrate the machine learning model. For example, the user interaction that indicates to the system to calibrate may be an act of the user speaking/repeating the incorrect word(s) loudly itself. In non-limiting examples, a user may at any time speak loud and, responsive to receiving a loud voice, the system may calibrate the model with both loud and silent voice.

It is appreciated that acts 168-174 in FIG. 1B are described only in an exemplary order. In other variations, acts 168-174 may be executed in any other order, and/or any act among acts 168-174 may be omitted.

Returning to FIG. 1A, in some embodiments, the feedback signal may include a haptic signal indicating a response to the user's speech. For example, the haptic signal may indicate a start/end of recognizing the user's speech. For example, once a user finishes a sentence (with a short pause), the system may send a vibration signal indicating the system has recognized the user's speech. In some embodiments, communication system 100 may further include a haptics device for receiving and outputting the haptic signal. For example, the haptics device may include a wearable device (e.g., 130), such as a smart watch, a vibration device, a wrist band, or any other suitable device. In a non-limiting example, the haptic signal may be a vibration signal which is sent to a smart watch and causes the smart watch to vibrate. The vibration signal may be of various frequency to indicate different feedback signal, in some embodiments.

In some embodiments, the feedback signal may include a waveform indicating a state of the speech system, where outputting the feedback signal may include displaying the waveform at least in part simultaneously with the user speaking. The waveform may be displayed at any of the display described above and further herein (e.g., display 148, 115). In non-limiting examples, the state of the speech system may include a start of recognizing speech. Additionally, the feedback signal may further include additional graphical user interface elements indicative of additional states of the speech system. For example, the additional states may include a second state indicating that the speech system is responding to the user's speech. The additional states may include a third state indicating that one or more actions have been executed or a response has been generated responsive to the user's speech.

FIG. 4 illustrates examples of user interface elements showing various states of a communication system, according to some embodiments. For example, user interface 402 includes a waveform 402-1 and an additional user interface element 402-2 to show the system has started recognizing the user's speech. In some embodiments, waveform 402-1 may be determined based on the EMG signal measured when the user is speaking silently. In other words, waveform 402-1 may change dynamically while the user is speaking. User interface element 402-2 may include a graphical symbol indicating a transitory state in which the user's speech is being recognized.

User interface 404, 406 may respectively indicate additional states of the system. For example, user interface 404 may include waveform 404-1 and a graphical element 404-2 (e.g., a rotating circle or spinning wheel) indicating the system is currently generating a response to the user's speech or taking one or more actions responsive to the user's speech. User interface 406 may include waveform 406-1 and a graphical element 406-2 (e.g., a checkmark) indicating the system has executed one or more actions responsive to the user's speech. Although examples of user interface elements of feedback signal are illustrated in FIG. 4, it is appreciated that variations of user interface elements or any combination thereof are also possible. The layout of the user interface elements may also vary. In addition, other suitable states of the system may also be indicated by the user interface elements as shown or other suitable user interface elements.

Although limited number of examples are illustrated in FIGS. 1A-4, it is appreciated that the feedback signal may include any suitable type in any suitable format. For example, the feedback signal may alternatively or additionally include an audio wave, an image, a video, or 2D/3D or other variable-dimensional representation of data for output on a respective output device.

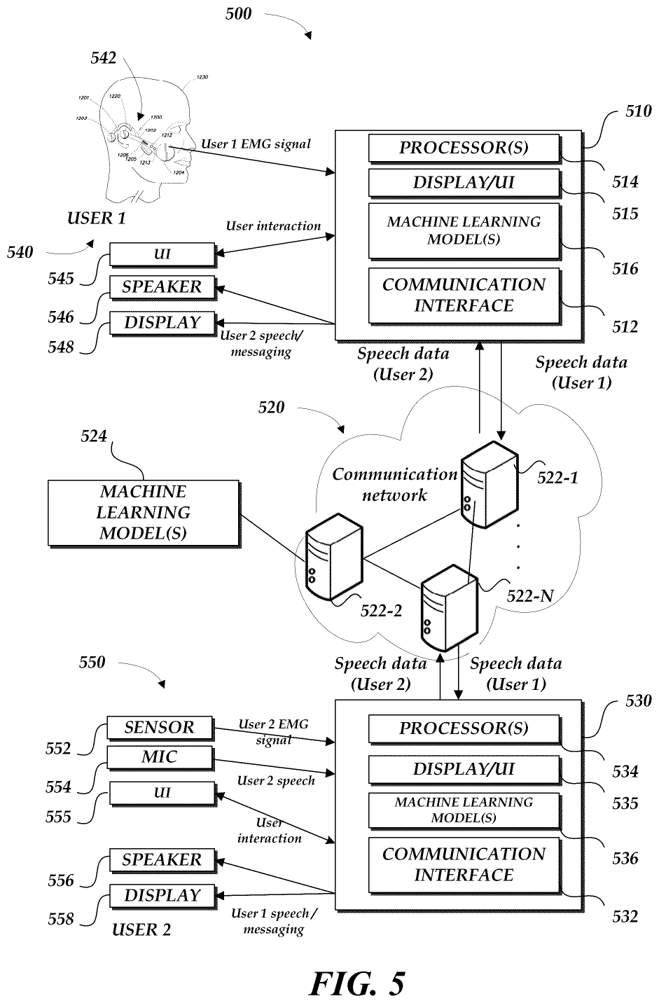

FIG. 5 illustrates example configurations of a communication system with two communication devices associated with two users in a call and a communication network, according to some embodiments. In some embodiments, a communication system 500 may include a communication device 510 associated with a first user (e.g., user 1), a communication device 530 associated with a second user (e.g., user 2), and a communication network 520. The communication devices 510, 530 may communicate with each other via the communication network 520 to facilitate a call between the first user and the second user. In some embodiments, the communication system may include a respective speech system associated with each user (e.g., 540 for user 1 and 530 for user 2), where the respective speech system is coupled to the communication device for that user. For example, speech system 540 may be coupled, wired or wirelessly (e.g., via Bluetooth), to communication device 510 associated with user 1. Speech system 550 may be coupled, wired or wirelessly (e.g., via Bluetooth), to communication device 530 associated with user 2.

In some embodiments, the speech system associated with a user (e.g., 540, 530) may include one or more sensors configured to measure various signals associated with a user speaking. For example, speech system 540 may include one or more EMG sensors configured to measure a signal indicative of the user's speech muscle activation patterns when the user is speaking silently (or loudly). In some examples, speech system 540 may also include an audio sensor (e.g., a microphone) configured to measure an audio signal of the user's speech when the user is speaking loudly or whispering. The system may transmit the capture signal(s) to the other user on the call. In some embodiments, the speech system may also be configured to receive an audio signal or text of the other user's speech in the call and playback or display the received signal of the other user on an output device (e.g., playback of audio of the other user on a speaker).

Although it is illustrated that a speech system or communication device may be associated with a user, it is appreciated that the speech system or communication device are not unique to a user. In other words, the speech system or communication device as illustrated may be associated with any user. For example, speech system 540 and/or communication device 510 may be interchangeably associated with user 2, or any other user.

With further reference to FIG. 5, in some embodiments, a silent call may be made where at least a party in the call is speaking silently. For example, as shown in FIG. 5, speech system 540 may include a speech input device 542. In some embodiments, speech input device 540 may be a wearable device, such as a headset, and may include an EMG sensor configured to capture the EMG signal when the user is speaking loudly or silently. Speech input device 542 may be coupled (e.g., wired or wirelessly) to a communication interface 512 of communication device 510, and transmit the EMG signal to the communication device. The communication interface 512 of communication device 510 may be configured to further communicate with communication device 530 on the communication network 520. Communication device 510 may include one or more processors 514 configured to determine speech data representing user 1's speech based on the EMG signal of the user's speech; and transmit the speech data representing user 1's speech to the communication device 530 via communication network 520.

In some embodiments, communication network 520 may be an Internet-based network or a cellular-based network, where the speech data representing the first user's or the second user's speech may be transmitted in any suitable protocol. For example, the speech data representing the user's speech (e.g., user 1 or user 2) may include spectrogram or audio, which may be transmitted via VOIP. In some examples, spectrogram or audio may be transmitted via a messaging protocol (e.g., via a cellular network), or an Internet-based text protocol (e.g., iMessage, slack, or other suitable protocols), where the receiver may receive audio of the other caller as a voice message. In some embodiments, the Internet-based network may be operated over the cellular network.

In some embodiments, communication device 510 may also be configured to receive speech data of user 2 from communication device 530. In some embodiments, communication device 510 may provide the speech data of user 2's speech in a suitable format (e.g., voice, text) to user 1 for output at speech system 540. For example, speech system 540 may further include a speaker 546 for playing back the audio signal of user 2's speech. Speaker 546 may be integrated in a wearable device (e.g., speech input device 542, a headset, a smart watch) or a portable electronic device (e.g., a smart phone). In some embodiments, speech system 540 may further include a display 548 for displaying the text transcribing the user 2's speech. The display may be installed in the speech system 540, e.g., as a pair of AR glasses or a wearable device.

With further reference to FIG. 5, the speech data representing the user's speech (e.g., user 1, user 2) may be of various forms, which can be generated at various computing devices along the communication path from speech system 540 to speech system 550 (e.g., any of speech systems 540, 550, communication devices 510, 530, or any computing device in the communication network 520). In some embodiments, the speech data representing the user 1's speech which is transmitted to the communication network 520 may include a spectrogram or an audio signal of user 1's speech that may be generated by processor(s) 514 of the communication device 510. In this configuration, the processor(s) 514 may use one or more machine learning model(s) 516 to convert the EMG signal received from the speech input device 542 to the spectrogram or audio signal of user 1's speech. The EMG signal may be indicative of user 1's speech muscle activation patterns when user 1 is speaking silently. Communication network 520 may transmit the spectrogram or audio signal of user 1's speech to communication device 530 associated with user 2 for playing back in user 2's speech system 550.

In some embodiments, the speech data representing user 1's speech may be generated at one or more processing devices in the communication network 520. For example, communication network 520 may include multiple hops (e.g., 522-1, 522-2, . . . , 522-N) configured to establish a communication link between communication device 510 and communication device 530. Each of the hops may include one or more processors for converting the EMG signal of a user's speech. For example, EMG signal of user 1's speech may be received at the communication network 520 from speech input device 542, and one or more processors on a hop (e.g., 522-2) in the communication network 520 may use a machine learning model(s) (e.g., 524) to convert the EMG signal received to the spectrogram or audio signal of the user 1's speech. Although machine learning model(s) 524 are described in this example to be associated with hop 522-2, it is appreciated that the machine learning model may be used by any of the hops in the communication network 520. Subsequently, the communication network may transmit the spectrogram or audio signal of the user's speech to the communication device associated with the other user in the call (e.g., communication device 530 for user 2) for receiving and playing back. For example, an audio signal of user 1's speech may be received at the speech system 550 and played back at a speaker 552 for user 2.

In some embodiments, the EMG signal of a first user's speech may be received at the communication device of a second user in the call. The communication device of the second user may process the EMG signal to generate the speech data representing the first user for playing back at a speech system of the second user. For example, EMG data of user 1 may be transmitted to the communication network 520 and received at communication device 530 associated with user 2. In such configuration, the processing of the EMG data may be performed on one or more processors 534 of communication device 530. For example, the one or more processors 534 may use one or more machine learning models 536 to convert the EMG data to a spectrogram or audio signal of user 1's speech for playback on the speech system 550.

In various embodiments, the speech data representing user 1's speech may be generated at multiple locations along the communication path between user 1 and user 2. For example, the processor(s) 514 of communication device 510 may be configured to receive the EMG signal of user 1's speech and convert the EMG data to a spectrogram of the user's speech, for example, using one or more machine learning models 514. Communication device 510 data may transmit the spectrogram data to communication network 520. Subsequently, a hop (e.g., 522) in communication network 520 may process the spectrogram data to generate an audio signal of user 1 for receiving by communication device 530 associated with user 2. Alternatively, and/or additionally, the spectrogram data of user 1's speech may be received at communication device 530, which converts the spectrogram data to the audio signal of user 1 for playing back at user 2's speech system 550.

In some embodiments, the determination that a type of speech data representing user 1's speech be generated at a suitable device may be determined based on one or more criteria. For example, the determination of which type of speech data of user 1 (e.g., EMG signal, spectrogram or audio signal) be transmitted to the communication network 520 to user 2 may be made depending on which type may result in lowest bandwidth on the communication network. In some embodiments, the determination may be made based on the computing power, availability, utilization rate of any given device along the communication path between the two users in the call.

Although signal flows from user 1 to user 2 are illustrated in the above embodiments in a communication path between the two users in a call, it is appreciated that the various components along the communication path may operate in a similar manner when the signal flows from user 2 to user 1 in the same call. For example, the speech data (e.g., spectrogram, auditory signal, or text) representing user 2's speech may be generated at communication device 530 and subsequently transmitted through the communication network 520 to communication device 510 associated with user 1. In other examples, the EMG signal of user 2's speech is received in the speech system 550 and transmitted to communication device 510 associated with user 1. Subsequently, communication device 510 may use one or more machine learning models 516 to convert the EMG data of user 2's speech to speech data for playing back at user 1's speech system 540.

Alternatively, and/or additionally, the speech data of user 2 may be generated at any hop (e.g., 522) in the communication network 520 and received at the communication device 510 for playing back at speech system 540. In a non-limiting example, the spectrogram of user 2's speech may be generated along the communication path between user 2 and user 1 and received at communication device 510 and further processed at the communication device 510 to generate an audio signal of user 2's speech for playing back on speaker 546. In another non-limiting example, the audio signal of user 2's speech is generated along the communication path between user 2 and user 1 and received at speech system 540 for playback on speaker 546.

As described in the various embodiments above and further herein, a machine learning model (e.g., 516, 524, 530) may be used to convert a user's EMG data to various types of speech data (e.g., spectrogram, audio signal, text etc.). In some embodiments, the machine learning model(s) (e.g., 516, 524, 536) may be a transduction model and trained using a plurality of training data and ground truth data to convert EMG data to another type of speech data, e.g., a spectrogram, an audio signal, text etc. The training data may include training EMG data that is collected when the training subject(s) are speaking silently or loudly. The ground truth data may include the spectrogram or audio associated with the training subject(s)'s speech. For example, the training subject(s) may be asked to speak loudly, whereas training EMG data may be collected (e.g., from EMG sensors) simultaneously with the ground truth data (e.g., spectrogram or audio wave forms), where the ground truth data may be generated from the training subject(s)'s vocalized speech. In some embodiments, the training subject(s) may be asked to speak silently, where training EMG data may be collected (e.g., from EMG sensors) and the ground truth data may be generated from text transcribing the training subject(s)'s silent speech, e.g., using text to speech synthesizing techniques to generate spectrograms or audio signals. In some embodiments, the text transcribing the training subject(s)'s silent speech may be generated using a silent speech model that is trained to convert from EMG data to text, detailed of which are described in embodiments in FIGS. 2E-2F discussed above.

In some embodiments, the machine learning model(s) (e.g., 516, 524, 536) may be trained to generate the spectrogram or audio signal of the user directly from EMG data. Alternatively, and/or additionally, any of the machine learning model(s) may have a plurality of portions configured to generate an audio signal of the user's speech via spectrogram. For example, a machine learning model (e.g., any of machine learning models 516, 524, 536) may include a first portion configured to convert the EMG data to a spectrogram, and a second portion configured to convert the spectrogram to the audio signal of the user's speech.

In some embodiments, a user may select the voice in which the user's speech should be played back to the other user in a call. Alternatively, a user in a call with another user may select the voice in which the other user's speech should be played back. For example, with reference to FIG. 5, user 1 is a silent caller (e.g., user 1 is speaking silently in the call). User 2 may select to hear the silent caller's speech in the silent caller's own voice or in a special voice. For example, user 1 may be the significant other of user 2. Whereas user 1 is speaking silently, user 2 may prefer to playback the synthesized voice that mimics user 1's true voice. Conversely, user 1 may also prefer that the audio signal of user 2's speech be played back in user 2's true voice. In some embodiments, a caller may prefer that the audio signal of the caller him/herself or the audio signal of the other user's speech be played back in any special voice, e.g., a female voice, a male voice, an adult's voice, a child's voice, a voice associated with an age group, or any combination thereof.

In some embodiments, a user's selection of voice may be made via a user interaction, e.g., via a user interface on a suitable device (e.g., user interface 545, 555 on speech system 540, 530; user interface 515, 535 on communication device 510, 530). For example, the user interaction may be a click of a button on the speech input device 542. In another example, the user interaction may be a click of a checkbox on user interface 515 of communication device 510. It is appreciated that the user interaction may include activation/deactivation of any suitable user interface elements in user interface 545, 555, 515, 535.

In non-limiting examples, the user selection of voice may be transmitted to the communication path between two callers in a call such that a computing device on the communication path may generate the user's speech data in the selected voice responsive to the user selection. For example, in a call between user 1 and user 2, user 1 may select to use user 1's true voice for synthesizing at user 2's end. The selection of the voice may be made on user 1's speech system 540 (e.g., via click(s) of button(s) on a wearable device). In another example, the selection of the voice may be made on user 1's communication device 510 (e.g., via user interface 515). User 1's selection of voice may be transmitted to the communication path between user 1 and user 2 such that any device on the path may receive the selection of voice.

In a non-limiting example, communication device 510 may be configured to convert user 1's EMG data to a spectrogram of user 1's speech. Communication device 510 may receive user 1's selection of voice (e.g., from speech system 540), and, responsive to the user selection, generate the spectrogram of user 1's speech in the selected voice, and transmit the generated spectrogram to user 2's communication device 530. In another non-limiting example, communication device 530 may be configured to convert user 1's EMG data to a spectrogram of user 1's speech. Communication device 530 may receive user 1's selection of voice (e.g., via communication network 520), and, responsive to the user selection, generate the spectrogram of user 1's speech in the selected voice. Alternatively, and/or additionally, a user's selection of voice may be transmitted to the communication network 520 such that the one or more processors on a hop in the communication work may be operated to generate the speech data in the selected voice responsive to the user selection.

In some embodiments, in generating speech data (e.g., spectrogram, audio signal) in a selected voice, the machine learning model(s) (e.g., 516, 524, 536) may be trained with various separate training data sets, each for a respective voice. In some embodiments, other techniques may be used. For example, an EMG signal for a user's silent speech may be converted to text transcribing the user's speech (e.g., using a speech model). The system may use a trained machine learning model to synthesize the text into an audio signal in the selected voice responsive to the user selection.

With further reference to FIG. 5, a user may receive the other user's speech on the call as text, which can be displayed to the user on a display. For example, text transcribing user 2's speech may be displayed in the speech system 540 associated with user 1, such as display 548, in lieu of, or in addition to playing back audio signal of user 2's speech. In some embodiments, text transcribing a user's (e.g., user 1, user 2) speech may be generated at various computing devices along the communication path between the user and the other user (e.g., user 2, user 1) in the call. Several non-limiting examples are further illustrated herein.

In a non-limiting example, the processor(s) 534 in communication device 530 may use a machine learning model(s) 536 to convert the EMG data of user 2's speech (e.g., via EMG sensor(s) in speech system 550) to text transcribing user 2's speech and transmit the text to communication device 510 associated with user 1 via the communication network 520. In another example, one or more processors of any hop (e.g., 522) in the communication network 520 may receive the EMG data of user 2's speech from communication device 530, use machine learning model(s) 524 to convert the EMG data to text transcribing user's speech, and transmit the text to communication device 510 associated with user 1. In another example, the EMG data of user 2's speech may be received at the communication device 510 associated with user 1, where one or more processors 514 may use machine learning model(s) 516 to convert the received EMG data to text transcribing the user 2's speech. In these configurations, the machine learning model(s), e.g., 516, 524, 536, may be trained in a similar manner as described above with respect to converting EMG data to spectrogram or audio signal of a user's speech, except that the ground truth data may include text transcriptions of training subjects' speech from which training EMG data is collected.

In various embodiments described above and further herein, during a call between two users, the text transcription of one user's speech may be displayed at the other user's display. For example, with reference to FIG. 5, text transcription of user 2's speech may be displayed on the display, e.g., 548 of speech system 540 associated with user 1. The display 548 may be installed on a laptop, a smart phone, a pair of AR glasses, a handset, or any suitable electronic portable device. For example, AR glasses may be configured to enable a user in a call to see the text of the other user's speech in an immersive way, where the user may quickly skim through the text without closely reading it. This enables the user in the call to be able to quickly digest what the other user is speaking.

In some embodiments, instead of, or in addition to displaying the text of the user's speech, a summary of the text transcribing the user's speech may be displayed. In some embodiments, the techniques described above and herein are also applicable to more than two callers in a call. Alternatively, and/or additionally, text for speech that has been spoken by any caller on a call may be generated on respective device(s) along the communication path(s) among the callers and displayed together on any user's display. In such configuration, a history of a conversation among two or more users in a call may be displayed in text.

In some embodiments, filler words in a user's speech may be removed before the speech data is received by the other user in the call. For example, an audio signal of the user's speech is generated, and the filler words may be removed from the audio signal. In a non-limiting example, the processor(s) 514 of the communication device 510 associated with user 1 may convert the EMG signal of user 1's speech to an audio signal of the user's speech in a manner as described above and further herein. The processor(s) 514 may further automatically remove filler words in the audio signal of the user's speech before transmitting the audio signal to the communication device 530 associated with user 2.

Alternatively, and/or additionally, removal of filler words may be performed on any suitable type of speech data representing the user's speech. For example, a spectrogram of a user's speech may be generated from the EMG data of the user (e.g., using a machine learning model as described above and further herein). Subsequently, filler words may be removed from the spectrogram before being converted to an audio signal of the user's speech, such that the resulting audio signal will have no filler words therein.

In some embodiments, filler words may be removed in the EMG signal before the EMG signal is processed and converted to a spectrogram or an audio signal of the user's speech, such that the resulting spectrogram or audio signal will have the filler words removed. In some embodiments, filler words may be removed in text transcribing the user's speech. For example, the EMG signal of a user's speech may be converted to text using the techniques described above and further herein. Then, filler words may be removed in the text transcribing the user's speech. The processed text may further be used to synthesize an audio signal of the user's speech (e.g., using text to speech techniques). The resulting synthesized audio signal will have filler words removed.

In some embodiments, the techniques for removing filler words in different types of speech data may be implemented in any suitable device along the communication path between callers (e.g., user 1, user 2) in a call, e.g., at communication devices 510, 530, or any hop (e.g., 522) in the communication network 520.

In some embodiments, the speech systems (e.g., 540, 550) or communication devices (e.g., 510, 530) associated with the callers in a call may be configured to receive user interactions for controlling the call. For example, speech system 540 or communication device 510 associated with user 1 may be configured to send a notification (e.g., a ring tone played on a speaker, light flashing on a device or display) to the user indicating there is an incoming call from user 2. User 1 may respond to the call via a suitable user interaction, e.g., making an utterance (such as “hmm,” “uh-uh”) or speaking a word (e.g., “yes,” “pick up,” “no” etc., silently or loudly), making a gesture (e.g., nodding/shaking head), or activating/deactivating a user interface element (e.g., a button, a slider bar), to indicate whether to accept or reject the call.

In some embodiments, communication device 510 may be configured to detect the user interaction in response to sending the notification of the call, and based on the user interaction, accept or reject the call. For example, responsive to detecting the user interaction that indicates the user accepts the call, communication device 510 may respond to the call and activate a communication link between communication devices 510, 530 for the call. Upon an end of the call (e.g., one or more users hang up), the communication link between communication devices 510, 530 of the users in the call may be deactivated.

In some embodiments, in detecting an utterance from user 1's speech, communication device 510 may be configured to use a machine learning model 516. For example, the machine learning model may be trained from training data comprising training subject(s)'s speech (silent or vocalized) comprising utterance and corresponding ground truth data indicating “accept” or “reject” in the training subject(s)'s speech.

In some embodiments, in detecting a word from user 1's speech for accepting or rejecting a call, communication device 510 may be configured to use a machine learning model 516. For example, the machine learning model may be trained from training data comprising training subject(s)'s speech (silent or vocalized) comprising the words for accepting/rejecting a call and corresponding ground truth data indicating “accept” or “reject” in the training subject(s)'s speech.

In some embodiments, in detecting a gesture of user 1 indicating accepting or rejecting a call, speech system 540 may include a sensor for detecting the user's gesture in response to the notification of the incoming call. For example, the sensor may include a camera configured to capture image(s)/video(s) of the user when the user is nodding or shaking head. Communication device 510 may apply image analysis techniques to the captured image(s)/video(s) to detect whether the user is nodding or shaking head. Alternatively, and/or additionally, the sensor may include an accelerometer installed on a wearable device such as a headset, where the accelerometer is configured to measure the movement of the user's head. Communication device 510 may detect whether the user is nodding or shaking head based on the movement of the user's head. In other variations, other techniques, such as machine learning model(s) may be used to detect whether the user is nodding or shaking head from the captured image(s) or sequence of image(s) of the user and/or accelerometer data associated with the user nodding/shaking head.

In some embodiments, speech system 540 or communication device 510 associated with user 1 may be configured to detect various user interactions to perform other call-related operations, such as, muting a call, holding a call, adding a new caller, accepting a new call, and/or switching a call. The user interactions for call operations may include making an utterance, speaking a word (e.g., silently or loudly), making a gesture, or activating/deactivating a user interface element in a similar manner as described above with respect to the user interactions for accepting/rejecting a call. The detection of the user interactions for performing the call-related operations may also be performed in a similar manner as detecting the user interaction for accepting/rejecting a call.

In some embodiments, additional information (besides speech data) may be transmitted between the users in a call. For example, the additional information may include graphical data associated with a character of user 1 may be transmitted from communication device 510 to the communication device 530 associated with user 2 for displaying on user 2's display 558. In some embodiments, the graphical data may include an avatar, an animated avatar, an emoji, and/or an animated emoji associated with user 1.

In some embodiments, a user's speech system (e.g., 540 associated with user 1) may include an image capturing device configured to capture one or more images of a face of the user while the user is speaking silently. The processor(s) 514 of the communication device 510 associated with the user may be configured to receive the captured image(s) of the face of the user and generate the avatar or the animated avatar of the user based on the received image(s).

In some embodiments, the additional information that is transmitted between the users on a call may include data that indicates whether a user is calling silently, where such data may be used by the other user in the call to take proper actions. For example, when user 1 and user 2 are on a call, user 2 receives data indicating that user 1 is calling silently, where such data may be output on a user interface element of user 2's device (e.g., speech system 550 or communication device 530), via a LED light, on a display, an audio output such as a beep, or a combination thereof.

Responsive to receiving the data indicating that user 1 is making a silent call, user 2 may take one or more actions e.g., via a user interaction on the user 2's device. For example, user 2 may select to also make a silent call because the fact that user 1 is making a silent call may indicate that the call is confidential. In such case, user 2 may trigger a user interaction (e.g., making an utterance, speaking a word, making a gesture, clicking a button etc.) to switch the call to a silent call. As a result, the speech system associated with the user may be switched to operate for a silent call, for example, activate EMG sensor for receiving measurement of user speech muscle activation patterns when the user is speaking silently, and/or configuring machine learning models for converting EMG data to other speech data such as spectrogram, audio, or text.

In some embodiments, data indicating whether the other user is calling silently may be received at a user's device any time before or during a call. For example, user 1 may receive a notification of an incoming call from user 2, and also receive data indicating that user 2 is calling silently. In response, user 1 may activate a user interface element (such as described above) to accept the call as a silent call. Responsive to user 1 accepting the call as a silent call, speech system 540 associated with user 1 will activate EMG sensor to receive EMG signals associated with user 1's speech.

In some examples, during a call with another user (e.g., user 2), user 1 may receive an indication (e.g., on a user interface of a device associated with user 1, e.g., speech system 540, communication device 510) indicating that the user 2 has switched to silent calling. Responsive to receiving the indication that user 2 has switched to silent calling, user 1 may trigger a user interface element (e.g., click of a button) or make a gesture to switch the call to silent calling. Responsive to user 1 switching to silent calling, speech system 540 or communication device 510 associated with user 1 will activate the EMG sensor to receive EMG signals associated with user 1's speech.

In some embodiments, the speech data associated with a user's speech may be translated into a different language before being played back on the other user's speech device. For example, user 1 and user 2 in a call may speak different languages, where the translation may be performed along the communication path between user 1 and user 2. In some embodiments, the translation may be performed on any type of speech data, such as audio, spectrogram, text, EMG data or other suitable types. The translation may be performed on any device along the communication path of the call, e.g., communication devices 510, 530, respectively associated with user 1 and user 2, or any hop in the communication network 520.

In variations of the embodiments described above and further herein, any user or device(s) associated with the user may be interchangeable with another user or device(s) associated with another user in the call. For example, speech system 550 of user 2 may be similar to speech system 540 of user 1. The communication device 530 of user 2 may be similar to communication device 510 of user 1. As such, speech systems 540, 550 and communication devices 510, 530 may be applicable to any user in a call.

In variations of the embodiments described above and further herein, speech systems 540, 550 and/or communication devices 510, 530 may be configured to enable a user to make a silent call and/or a vocalized call. For example, any of user 1 and user 2 may make a silent call and/or a vocalized call. In non-limiting embodiments, user 1 is making a silent call whereas user 2 is also making a silent call. In this case, EMG data of user 1 may be converted to speech data representing user 1's speech for receiving and/or playing back at speech system 550 and/or communication device 530 associated with user 2. EMG data of user 2 may be converted to speech data representing user 2's speech for receiving and/or playing back at speech system 540 and/or communication device 510 associated with user 1.

In non-limiting embodiments, user 1 is making a silent call whereas user 2 is making a vocalized call. In this case, EMG data of user 1 may be converted to speech data representing user 1's speech for receiving and/or playing back at speech system 550 and/or communication device 530 associated with user 2. Audio signals of user 2 (e.g., captured by an audio input device, such as a microphone) may be converted to speech data representing user 2's speech for receiving and/or playing back at speech system 540 and/or communication device 510 associated with user 1. For example, the audio signals of user 2 may be converted text or spectrogram, e.g., using acoustic speech recognition (ASR) techniques.

In variations of the embodiments described above and further herein, the sensor(s) (e.g., EMG sensors or other types of sensors) and output devices (e.g., speaker, display, user interface) of speech system (e.g., 540) of user 1 may be installed on communication device 510 of the user and configured to perform similar operations. As such, when a particular embodiment is described with respect to operations of speech system (e.g., 540), such embodiment may also be implemented in communication device (e.g., 510) of the user in a similar manner.

In variations of the embodiments described above and further herein, the machine learning model(s), e.g., 516, 524, 536 may implement any of the techniques described above and further herein, such as a transduction model for converting EMG data to speech data representing the user's speech (e.g., audio, spectrogram, text etc.), text-to-speech techniques, ASR, language translation, or a combination thereof.

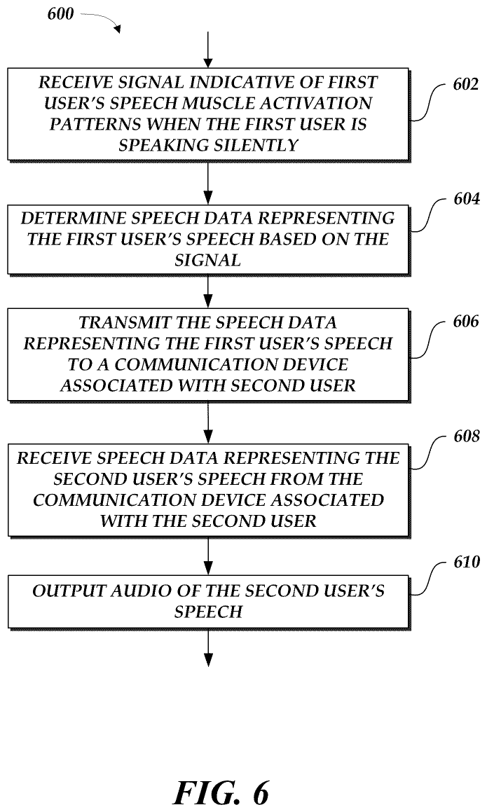

FIG. 6 is a flow chart showing an exemplary computerized method 600 for generating and transmitting speech data representing a user speech in a silent call to a communication network, according to some embodiments. In some embodiments, method 600 may be implemented in a communication device associated with a caller (e.g., communication devices 510, 530). Method 600 may include receiving a signal indicative of a first user's speech muscle activation patterns when the first user is speaking silently, at act 602. As described above with respect to FIG. 5, act 602 may be performed by speech system 540 associated with user 1, where the speech system may include an EMG sensor configured to measure EMG data indicative of the user's speech muscle activation pattern when the user is speaking (e.g., silently or vocally). A communication device (e.g., 510) associated with user 1 may be coupled to speech system 540 (e.g., wired or wirelessly such as via Bluetooth) and receive the EMG data.

Returning to FIG. 6, in some embodiments, method 600 may further include determining speech data representing the first user's speech based on the signal, at act 604; and transmitting the speech data representing the first user's speech to a communication device associated with a second user, at act 606. As described above with respect to FIG. 5, act 604 may be performed on a suitable device, e.g., communication device 510 associated with user 1, to determine speech data representing user 1's speech based on the EMG signal. For example, act 604 may use one or more machine learning models 516 to generate a spectrogram or an audio signal of user 1's speech based on the EMG signal. In act 606, communicative device 510 may transmit the spectrogram or audio signal of user 1's speech to the communication device 530 associated with user 2, via communication network 520.

In other variations, acts 604, 606 may be implemented on a hop (e.g., 522) in the communication network 520. In other variations, acts 604, 606 may be implemented on communication device 530 associated with user 2. Other variations are described above with respect to FIG. 5. For example, act 604 may be partially implemented on communication device 510 to generate a spectrogram based on the EMG data, and transmit the spectrogram to the communication network 520. A hop (e.g., 522) in the communication network may generate an audio signal of the user's speech based on the spectrogram. In other variations, the communication device 530 associated with user 2 may receive the spectrogram from the communication network 520 and generate the audio signal of user 1's speech based on the spectrogram.

With further reference to FIG. 6, method 600 may include receiving speech data representing the second user's speech from the communication device associated with the second user, at act 608; and outputting the audio signal of the second user's speech, at act 610. For example, with reference to FIG. 5, acts 608, 610 may be implemented on communication device 510 associated with user 1 for receiving and playing back the audio signal of user 2 at speech system 540. In some embodiments, the speech data representing user 2 received at communication device 510 may be EMG data of user 2. In such case, communication device 510 may use one or more machine learning models 516 to generate the spectrogram or audio signal of user 2 for receiving and playing back at speech system 540. In some embodiments, the speech data representing user 2 received at the communication device 510 may include a spectrogram of user 2 generated at a suitable device along the communication path, for example, communication device 530 associated with user 2, or a hop (e.g., 522) in the communication network 520.

Consequently, communication device 510 may generate the audio signal of user 2 based on the spectrogram.

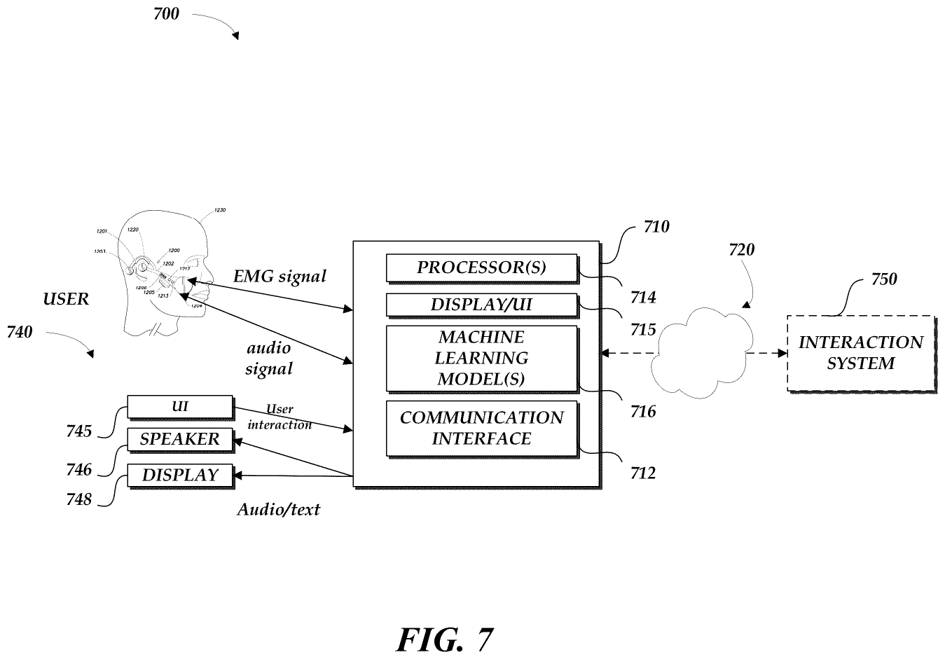

FIG. 7 illustrates an example communication system 700 that measures both the signal indicative of a user's speech muscle activation patterns (e.g., EMG signal) and the audio signal when the user is speaking loudly, according to some embodiments. In some embodiments, communication system 700 may include a speech system 740 and communication device 710 associated with a user, where the speech system 740 may be coupled to the communication device 710, wired or wirelessly (e.g., via Bluetooth). Speech system 740 may be configured in a similar manner as speech systems 540, 550 (FIG. 5).

In some embodiments, communication system 700 enables a user to speak loudly in a noisy environment and capture both audio signal and EMG data when the user is speaking. Subsequently, the system may use the EMG data to remove the background noise from the captured audio signal. With reference to FIG. 7, speech system 740 may include sensor(s) configured to measure a signal indicative of a user's speech muscle activation patterns when the user is speaking. For example, speech system 740 may include EMG sensor(s) configured to measure an EMG signal of the user when the user is speaking (silently or loudly). In some embodiments, speech system 740 may have an audio sensor (e.g., microphone) configured to receive an audio signal of the user's speech when the user is speaking loudly.

In some embodiments, speech system 740 may also include a user interface 745 configured to receive user interactions(s) for controlling the communication system. For example, user interface 745 may detect user interaction(s), such as a user's gesture command, a user's speech command, and/or a control of a user interface element (e.g., a button). In some embodiments, speech system 740 may also include output devices such as a speaker 746 and/or a display 748, as described above and further herein. The speaker 746 and display 748 may be configured to receive data from the communication device 710 for output.

With further reference to FIG. 7, communication system 700 may include a communication device 710 coupled to the speech system 740 to receive the captured data (e.g., EMG signal, audio signal) from the speech system and/or provide output data (e.g., audio, text) to the speech system 740 for playback. For example, the communication device 710 may include a communication interface 712 configured to communicate with the speech system 740 wired or wirelessly (e.g., via Bluetooth), to receive sensor data (e.g., EMG signal, audio signal) captured from the speech system when the user is speaking. Communication device 710 may include one or more processors 714 configured to apply voice isolation techniques to the received audio signal by removing noise in the audio signal based on the EMG signal. In some embodiments, communication interface 712 may also be configured to receive other data from the speech system, such as user interactions from user interface 745. In some embodiments, the communication interface 712 may be configured to provide output data, such as audio/text data to the speech system for playback at speaker 746/display 748, respectively.

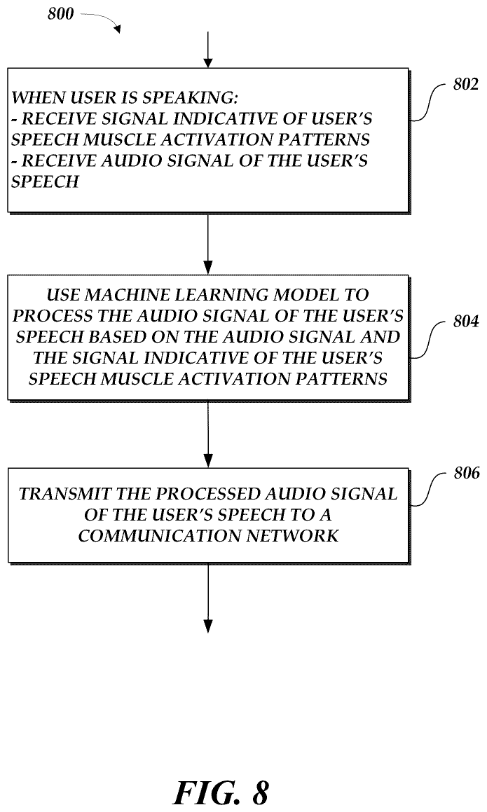

FIG. 8 is a flow chart showing an exemplary computerized method 800 for processing and transmitting an audio signal of a user speech in a speech system, where the processing includes removing noise from the audio signal using a signal indicative of the user's speech muscle activation patterns when the user is speaking, according to some embodiments. In some embodiments, method 800 may be implemented by one or more processors 714 in the communication device 710 (FIG. 7). For example, method 800 may include, when the user is speaking, receiving a signal (e.g., EMG data) indicative of the user's speech muscle activation patterns and receiving an audio signal of the user's speech, at act 802. The received signals (e.g., EMG signal or audio signal) may be captured from sensor(s) at the speech system (e.g., 740).

In some embodiments, method 800 may further include using machine learning model(s) (e.g., machine learning model(s) 716 in FIG. 7) to process the audio signal of the user's speech based on the audio signal and the signal indicative of the user's speech muscle activation patterns (e.g., EMG signal), at act 804. For example, processing the audio signal may include using the machine learning model(s) to remove noise in the audio signal based on the EMG signal. In some embodiments, the machine learning model(s) may be trained with voice training data and EMG training data collected in a noise-free environment. The machine learning model(s) may be trained further based on additional training data which includes the voice training data and EMG training data collected in the noise-free environment with added noise.

Additionally, and/or alternatively, communication 700 may be configured to remove other artifacts in the audio signal. For example, the one or more processor 714 of the communication device 710 may process the audio signal by removing some artifacts in a user's speech for people with speech disorders. For example, stuttering in a user's speech may be corrected. In another example, articulation errors (e.g., lisp) in a speech may be corrected. Various techniques may be used to correct the errors in the speech by processing the audio signal based on the EMG signal (and/or audio signal).

Additionally, and/or alternatively, communication 700 may be configured to modify some attributes of the voice in the audio signal. For example, communication device 710 may be configured to change the intonation in the user's speech to a more confident version, change the pitch of the voice to sound more energetic. Various techniques may be used to change the attributes of the user's voice based on the EMG signal (and/or audio signal).

With further reference to FIG. 8, method 800 may further include transmitting the processed audio signal of the user's speech to a communication network, at act 806. For example, the processed audio signal (with noise removed) may be transmitted to a communication network 720 via the communication interface 712 (FIG. 7).

In non-limiting embodiments, an interaction system 750 may be coupled to the communication network 720 to receive the processed audio signal of the user's speech (e.g., voice commands, prompts). Based on the received processed audio signal of the user's speech, the interaction system 750 may take one or more actions, or generate a response. The interaction system 750 may provide the response to the user through the communication device 710. For example, in response to a prompt by the user, an audio signal or text representing a response may be transmitted from the interaction system 750 to the speech system 740 for output at an output device (e.g., speaker 746, display 748).

In other variations, the communication device 710 may communicate with other communication devices through the communication network 720. For example, the speech system 740 and communication device 710 may be used in a call system (e.g., communication system 500 in FIG. 5), where the user can speak loudly in a noise environment and the audio signal of the user's speech is processed to remove the background noise before being transmitted to the other user in the call.

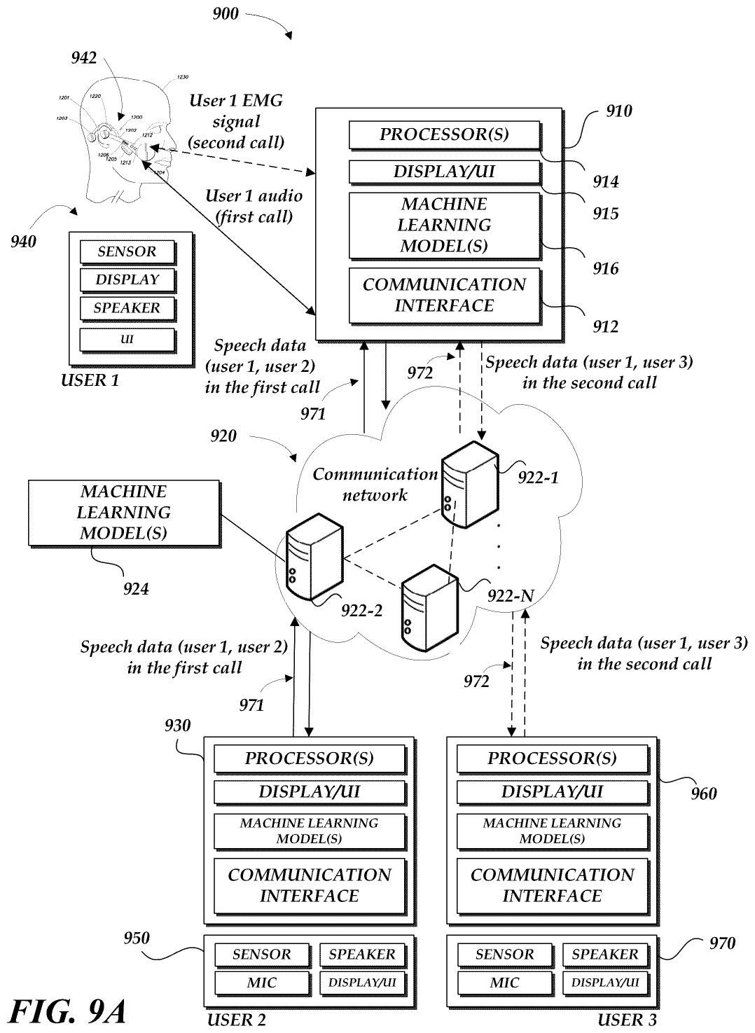

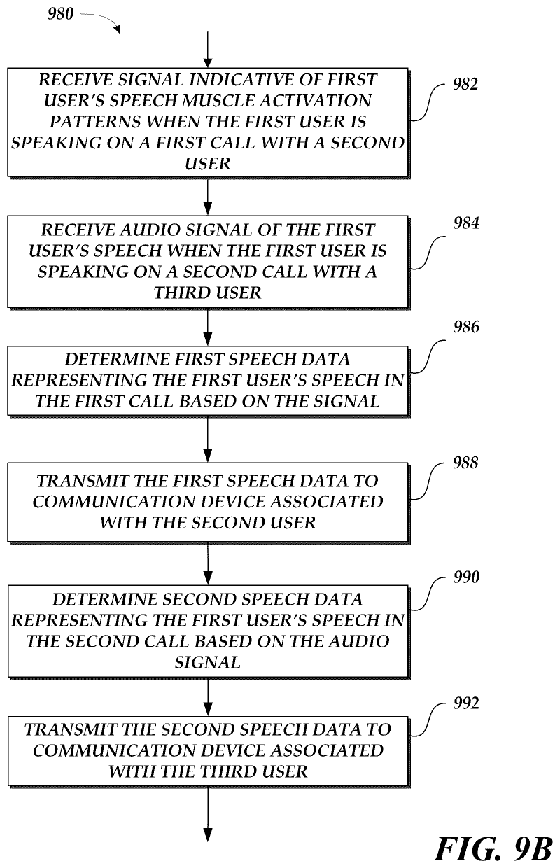

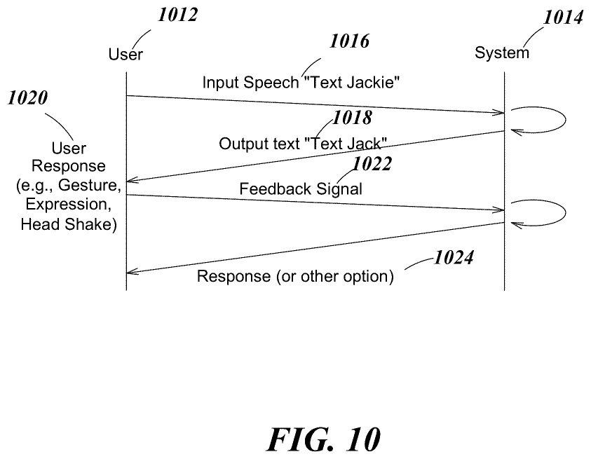

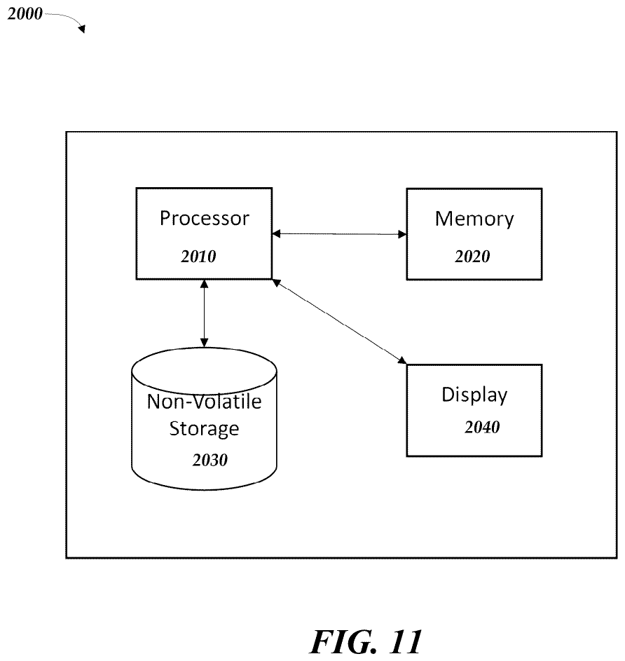

FIG. 9A illustrates example configurations of a communication system 900 capable of handling two calls in a communication network, according to some embodiments. Communication system 900 may be configured similarly to communication system 500 with a difference being that a communication device (e.g., 910) associated with a first user may communicate with multiple communication devices (e.g., 930, 960) associated with other users simultaneously. Such configuration may enable a user to be in multiple calls with multiple users.

As shown in FIG. 9A, communication system 900 may include speech system 940 and communication device 910 associated with a first user (e.g., user 1), and speech system 950 and communication device 930 associated with a second user (e.g., user 2) configured in a similar manner as speech system 540/communication device 510 and speech system 550/communication device 530 are configured in FIG. 5. In addition, communication system 900 may also include speech system 970 and communication device 960 associated with a third user (e.g., user 3), to which any other speech system and communication device associated with other users (e.g., user 1, user 2) may communicate via a communication network 920. As shown in FIG. 9A, two calls can be established for user 1: a first call with user 2 (the communication path is drawn in solid lines) and a second call with user 3 (the communication path is drawn in dashed lines). The communication paths for the first and second calls may each be similar to the communication path for the call as described in embodiments in FIG. 5. Details of handling the two calls in communication system 900 are further described with respect to FIG. 9B.

FIG. 9B is a flow chart showing an exemplary computerized method 980 for handling two calls in a communication system, according to some embodiments. In some embodiments, method 980 may be implemented in communication system 900, such as the speech system 940 and/or communication 910 associated with user 1. In some embodiments, user 1 may be on a first call with a second user (e.g., user 3 in FIG. 9A) and on a second call with a third user (e.g., user 2 in FIG. 9A). In non-limiting embodiments, the first call may be a silent call, in which the user may speak silently; the second call may be a vocalized call, in which the user may speak loudly. However, it is appreciated that any combination of silent/vocalized calls may be possible, and each call may be independently configured.

In some embodiments, to facilitate the first and second calls described above, method 980 may include receiving a signal indicative of a first user's speech muscle activation patterns when the first user is speaking on a first call (silent call) with the second user, at act 982; and receiving an audio signal of the user 1's speech when the first user is speaking on a second call (vocalized call) with the third user, at act 984. For example, speech system 940 associated with user 1 may include an EMG sensor configured to measure an EMG signal indicative of user 1's speech muscle activation patterns when user 1 is on a silent call with user 3. Speech system 940 may additionally include an audio sensor (e.g., a microphone) to record an audio signal of user 1's speech when the user is on a vocalized call with user 2. Communication device 910 may be coupled to speech system 940 to receive the EMG signal and audio signal of user 1's speech respectively from the silent and vocalized calls.

In some embodiments, method 980 may further include determining first speech data representing the first user's speech in the first call based on the signal (e.g., EMG data) indicative of the first user's speech muscle activation patterns when the first user is speaking silently on the first call, at act 986; and transmitting the first speech data to the communication device associated with the second user, at act 988. For example, the speech data for user 1 may include any suitable type such as EMG data, spectrogram, audio, and/or text as described above and further herein. In some embodiments, the speech data for user 1 may be generated based on the captured EMG data at any suitable computing device along the communication path between user 1 and user 3 (the path shown in dashed lines), in a similar manner as described in embodiments in FIGS. 5 and 6. Similar to FIGS. 5 and 6, act 988 may transmit the first speech data of user 1 to the communication device 960 associated with user 3 via communication network 920. Communication network 920 may be similar to communication network 520 (FIG. 5).

With further reference to FIG. 9B, method 980 may further include determining second speech data representing the first user's speech in the second call based on the audio signal of the first user when the first user is speaking on the second call with the third user, at act 990; and transmitting the second speech data to the communication device associated with the third user, at act 992. For example, the speech data representing user 1's speech in a vocalized call with user 2 may include audio data captured from speech system 940 when user 1 is speaking loudly, or any other suitable type of speech data, such as text transcribed from the audio signal. In some embodiments, act 992 may transmit the speech data of user 1 to communication device 930 associated with user 2 via communication network 920.

The communication system 900 (FIG. 9A) and method 980 (FIG. 9B) may be implemented to enable various scenarios of multiple calls. In some embodiments, two calls that can be facilitated by the communication system 900 may include a primary call and a secondary call. For example, user 1 may be on a primary call (e.g., a regular call) with user 2 using loud speech, and can also talk with user 3 on a secondary call (e.g., a background call talking with user 1's assistant or any other party) using silent speech. In such scenario, user 2 on the regular call with user 1 will not hear user 1's conversation with user 3 because user 1 is speaking silently on the secondary call with user 3. To facilitate the primary (regular) call, communication device 910 associated with user 1 may be configured to establish a first communication path (e.g., 971) with the communication device 930 associated with user 2 to facilitate a regular call. For example, speech system 940 associated with user 1 may receive audio signal of user 1's speech via an audio sensor (e.g., a microphone) when user 1 is speaking loudly. The audio signal of user 1's speech is transmitted from communication device 910 to communication device 930 via the first communication path 981. In other variations, as describe above and further herein, in lieu of an audio signal, other types of speech data of user 1's speech may be generated (e.g., at communication device 910) and transmitted through the communication path 971.

To facilitate the secondary (background) call, communication device 910 associated with user 1 may be configured to establish a second communication path (e.g., 972) with communication device 960 associated with user 3 to facilitate a silent call. For example, a sensor (e.g., EMG sensor) of speech system 940 associated with user 1 may measure EMG signal indicative of user's speech muscle activation patterns when user 1 is speaking silently. The EMG signal of user 1's speech is transmitted from the communication device 910 to communication device 960 via the second communication path 972. In other variations, as described above and further herein, in lieu of EMG signal, other types of speed data (e.g., spectrogram, or audio) of user 1's speech may be generated (e.g., at communication device 910) and transmitted through the communication path 972.

Although it is shown that the primary call may be a regular call (with vocalized speech) and the secondary call may be a silent call, it is appreciated that a user may speak loudly, silently, or whisper on any call regardless of whether the call is a primary call or a secondary call. It is also appreciated that various sensors (e.g., audio sensor, EMG sensor etc.) may be activated to capture respective types of signals (e.g., audio signal, EMG signal) on any type of call. For example, the EMG sensor of a speech system may be activated to capture EMG data regardless of whether the user speaks loudly, silently, or whisper. The audio sensor (e.g., a microphone) of a speech system may be activated to capture the audio signal when the user speaks loudly, or whisper.

In some embodiments, the communication device associated with a user may be configured to switch between a first call and a second call. For example, communication device 910 associated with user 1 may be configured to toggle between a first call (e.g., with user 2) and a second call (e.g., with user 3) responsive to receiving a user interaction indicative of a switch between the first call and the second call. The user interaction may include one or more of: a gesture, an utterance, a voice command, a silent speech command, or an activation/deactivation of a user interface element (e.g., a button, a slider). In non-limiting scenarios, the system may detect a body gesture (e.g., nodding or shaking head from the user, which may indicate accepting/rejecting a call); the system may detect an utterance in the speech (e.g., “hmm,” “uh-uh” which may indicate accepting/rejecting a call); the system may detect a voice command in the speech (e.g., “yes,” “no” or other commands); the system may detect a command in a silent speech (e.g., using a speech model based on the EMG signal of the user's speech). These various user interactions may indicate various operations associated with switching of calls, making calls, or any suitable operations associated with a call. For example, the user interactions may indicate muting a call, holding a call, adding a new caller, accepting a new call, switching a call, ending a call etc.

In some embodiments, the user interactions may be detected at the speech system or communication device associated with the user, such as speech system 940 or communication device 910 associated with user 1. For example, speech system 940 or communication device 910 may include a camera configured to capture user 1's gesture when the user is making a call. In other examples, the user interface of speech system 940 or communication device 910 may include a button, a slider, a touch pad or other widgets which may enable the user to select certain operations.

Responsive to receiving the user interactions, various components in the communication system (e.g., 900) may control the operation(s) of the communication system to respond to the user command(s) in the user interactions. For example, responsive to detecting a user interaction indicating accepting a call, the communication device associated with the user may cause to activate a communication link between the user and the other user who initiated the call. Responsive to detecting a user interaction indicating ending a call, the communication device associated with the user may cause to deactivate the communication link for the call.

In some embodiments, a first call between a first user and a second user may be operated over a constant communication link between the communication device associated with the first user and the communication device associated with the second user, whereas a communication for a second call between the communication device associated with the first user and the communication device associated with the third user may be activated/deactivated responsive to receiving a signal indicating a start/end of the second call. In some embodiments, the communication protocols for the first call and the second call may be different. For example, the first (constant communication) call may use a paging protocol, whereas the second call may use a VOIP protocol.

In a non-limiting example, a user may be on a constant communication link (e.g., a paging communication link) with an assistant, in which the user may speak silently to the assistant anytime. For example, as described above and further herein, speech system 940 associated with user 1 may include an EMG sensor configured to measure the EMG signal indicative of user 1's speech muscle activation patterns when user 1 is making the call, and transmit the EMG signal (or other speech data generated therefrom) to the assistant on the other end without needing to activate the communication link between the users because the call is on a constant communication link. In some embodiments, before the user on the constant communication link talks, the user may make a gesture (e.g., nodding head or other gestures, voice commands, user interactions etc.) to indicate that the user is about to speak (similar to pushing a button on a pager before the user is about to speak). In response to detecting the gesture, the system triggers capturing the user's silent speech (e.g., EMG data) when the user speaks and subsequently transmits the EMG data (or other speech data generated therefrom) to the communication device associated with the assistant for playing back to the assistant.

In a non-limiting example, independent from the call with the assistant on the constant communication link, the user is free to make or accept a second call with another user. For example, as describe above and further herein, the second call may be a vocalized call and may be made over a VOIP communication link. It is appreciated that any of the user interactions described with respect to the control of a call, such as switching a call, accepting a new call, muting a call etc. may also be applied.

As discussed above, the systems and embodiments discussed above may include gesture/expression recognition to indicate whether the system has recognized the speech correctly. FIG. 10 illustrates an exemplary implementation of gesture/expression recognition to indicate whether the system has recognized the speech correctly. User 1012 may speak (vocalized or silently) input speech 1016 including the words “Text Jackie.” System 1014 may receive the input speech 1016 and output to user 1012 the output text 1018 including the words “Text Jack.” User 1012 may then provide a user response 1020 including at least a gesture or expression, for example a head shake. The gestures or expressions may be detected using one or more sensors (e.g., EMG, IMU, optical sensors, etc.). In some embodiments, the gesture or expression may be a non-verbal gesture such as an eye roll or a head shake. In some embodiments, an eye roll may be tracked by on EMG sensor. In some embodiments, a head shake may be tracked by an accelerometer or an IMU. The detected gesture(s) or expression(s) may be provided to the system 1014 as feedback signal 1022. System 1014 may receive the feedback signal 1022 and output a response 1024. In some embodiments, the response may be corrected text. In other embodiments, the response may be some other suitable indication of the system receiving the feedback signal 1022.

In some embodiments, these gestures and expressions may indicate whether the system has recognized the speech correctly. For example, as shown in FIG. 10, suppose the user speaks the words “Text Jackie” and the system outputs the auditory feedback signal as “Text Jack.” The user may provide and the system may detect a head shake to indicate that the system has recognized the speech incorrectly. In some embodiments, the user may provide and the system may detect other negative gestures or expressions alone or in combination to indicate whether the system has recognized the speech correctly. In some embodiments, the user may provide and the system may detect a verbal signal in combination with the gesture or expression to indicate whether the system has recognized the speech correctly.

Having described several embodiments of the invention in detail, various modifications and improvements will readily occur to those skilled in the art. Such modifications and improvements are intended to be within the spirit and scope of the invention. For example, in FIGS. 5-9B, the speech system and/or communication device associated with any user may additionally include one or more features described in other embodiments. For example, the feedback systems and methods described in embodiments with respect to FIGS. 1A-4 may also be implemented in the speech system (e.g., 540, 550 in FIG. 5; 940, 950, 970 in FIG. 9A) and/or communication device (510, 530 in FIG. 5; 910, 930, 960 in FIG. 9A). Similarly, gesture/expression detection associated with silent speech as described in embodiments with respect to FIG. 10 may also be implemented in the speech system (e.g., 540, 550 in FIG. 5; 940, 950, 970 in FIG. 9A) and/or communication device (510, 530 in FIG. 5; 910, 930, 960 in FIG. 9A).

In other variations, although FIG. 5 shows one communication path for one call, and FIG. 9A shows two communication paths for two calls, it is appreciated that the embodiments in FIGS. 5 and 9A may also be implemented to facilitate any suitable number of calls for any suitable number of callers on any suitable number of communication paths. In other variations, the caller/receiver, first user/second user, first call/second call, primary call/secondary call etc. as described in various embodiments above are interchangeable. Any speech system described in various embodiments may include suitable sensors configured to capture suitable types of signals when the user speaks loudly, whispers, or speaks silently.

In other variations, the voice isolation features described in embodiments in FIGS. 7 and 8 may also be implemented in any speech system (e.g., 540, 550 in FIG. 5; 940, 950, 970 in FIG. 9A) and/or communication device (510, 530 in FIG. 5; 910, 930, 960 in

FIG. 9A).

An illustrative implementation of a computer system 2000 that may be used to perform any of the aspects of the techniques and embodiments disclosed herein is shown in FIG. 10. For example, the computer system 2000 may be installed in any of systems 100 (FIG. 1A), 500 (FIG. 5), 700 (FIG. 7), 900 (FIG. 9A). For example, the computer system 2000 may be configured to implement various embodiments in FIG. 1A, e.g., speech system 140, communication device 110. In other embodiments, system 2000 may be configured to implement various embodiments in FIG. 5, e.g., speech system 540/communication 510, speech system 550/communication device 530. In other embodiments, system 2000 may be configured to implement various embodiments in FIG. 7, e.g., speech system 740/communication 710. In other embodiments, system 2000 may be configured to implement various embodiments in FIG. 9A, e.g., speech system 940/communication 910, speech system 950/communication device 930, speech system 970/communication device 960. In other embodiments, system 200 may be configured to implements various processes, e.g., 160 (FIG. 1B), 220 (FIG. 2A), 200 (FIG. 2B), 270 (FIG. 2C), 250 (FIG. 2D), 380 (FIG. 3D), 600 (FIG. 6), 800 (FIG. 8), 980 (FIG. 9B).

The computer system 2000 may include one or more processors 2010 and one or more non-transitory computer-readable storage media (e.g., memory 2020 and one or more non-volatile storage media 2030) and a display 2040. The processor 2010 may control writing data to and reading data from the memory 2020 and the non-volatile storage device 2030 in any suitable manner, as the aspects of the invention described herein are not limited in this respect. To perform functionality and/or techniques described herein, the processor 2010 may execute one or more instructions stored in one or more computer-readable storage media (e.g., the memory 2020, storage media, etc.), which may serve as non-transitory computer-readable storage media storing instructions for execution by the processor 2010.

In connection with techniques described herein, the one or more processors 2010 may be configured to implement various embodiments described in FIGS. 1A-9B. For example, the one or more processors 2010 may be part of a computer system (e.g., 100 in FIG. 1A) or any components thereof, e.g., speech system 140, communication device 110. The one or more processors may include a DSP, a secondary computing device, a phone processor, a tensor processor, a laptop or desktop computing device, and/or a cloud computing instance (e.g., a virtual machine).

In connection with techniques described herein, code used to, for example, generate speech data representing a user's speech, may be stored on one or more computer-readable storage media of computer system 2000. Processor 2010 may execute any such code to provide any techniques for generate the speech data as described herein. Any other software, programs or instructions described herein may also be stored and executed by computer system 2000. It will be appreciated that computer code may be applied to any aspects of methods and techniques described herein. For example, computer code may be applied to interact with an operating system to operate the communication system (e.g., 100 in FIG. 1A, 500 in FIG. 5, 700 in FIG. 7, 900 in FIG. 9A) through conventional operating system processes.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

What is claimed is:

1. A communication system for making and receiving a call, the system comprising:
a speech system associated with a first user, the speech system configured to measure a signal indicative of speech muscle activation patterns of the first user when the first user is speaking;
a communication interface configured to communicate with a communication device associated with a second user on a communication network; and
one or more processors configured to:
determine speech data representing speech of the first user based on the signal indicative of the speech muscle activation patterns of the first user when the first user is speaking silently;
transmit the speech data representing the speech of the first user to the communication device associated with the second user on the communication network using the communication interface;
receive speech data representing speech of a second user from the communication device associated with the second user on the communication network using the communication interface; and
output audio of the speech of the second user based on the received speech data representing the speech of the second user.

2. The communication system of claim 1, wherein the speech system is a wearable device comprising an electromyography (EMG) sensor, whereby the signal indicative of the speech muscle activation patterns of the first user when the first user is speaking silently comprises EMG data received from the EMG sensor when the first user is speaking silently.

3. The communication system of claim 2, wherein:
the speech data representing the speech of the first user comprises a spectrogram or audio of the speech of the first user; and
the one or more processors are further configured to use a machine learning model to convert the EMG data to the spectrogram or audio of the speech of the first user.

4. The communication system of claim 3, wherein the one or more processors are further configured to use the machine learning model to convert the EMG data to the spectrogram or audio of the speech of the first user in a selected one of a plurality of voices responsive to receiving a user selection indicating the selected one of the plurality of voices.

5. The communication system of claim 3, wherein converting the EMG data to the audio of the speech of the first user comprises:
using a first portion of the machine learning model to convert the EMG data to the spectrogram; and
using a second portion of the machine learning model to convert the spectrogram to the audio of the speech of the first user.

6. The communication system of claim 2, wherein:
the communication network comprises one or more computing devices configured to process the EMG data associated with the first user to generate a spectrogram or audio of the speech of the first user for receiving by the communication device associated with the second user.

7. The communication system of claim 1, wherein the received speech data from the communication network representing the speech of the second user comprises audio of the second user.

8. The communication system of claim 1, wherein:
the received speech data from the communication network representing the speech of the second user comprises EMG data or spectrogram data associated with the speech of the second user; and
the one or more processors are further configured to use a machine learning model to convert the EMG data or spectrogram data to the audio of the speech of the second user.

9. The communication system of claim 8, wherein the machine learning model is trained to generate the audio of the speech of the second user in a selected one of a plurality of voices.

10. The communication system of claim 1, wherein:
the speech data representing the speech of the first user comprises audio of the speech of the first user; and
transmitting the speech data representing the speech of the first user to the communication device associated with the second user on the communication network is performed using a text protocol.

11. The communication system of claim 10, wherein the one or more processors are further configured to use a machine learning model and the signal indicative of the speech muscle activation patterns of the first user when the first user is speaking silently as input to the machine learning model to generate the audio of the speech data representing the speech of the first user.

12. The communication system of claim 1, wherein:
the speech data representing the speech of the first user comprises audio of the speech of the first user; and
the one or more processors are further configured to:
generate the audio of the speech of the first user based on the signal indicative of the speech muscle activation patterns of the first user when the first user is speaking silently; and
automatically remove filler words in the audio of the speech of the first user before transmitting the audio of the speech of the first user to the communication device associated with the second user on the communication network.

13. The communication system of claim 1, wherein the one or more processors are configured to accept a call from the second user before receiving the speech data representing the speech of the second user from the communication device associated with the second user on the communication network using the communication interface, wherein accepting is performed in response to receiving a gesture or an utterance from the first user.

14. The communication system of claim 13, wherein the one or more processors are configured to receive data from the communication network indicating that the call from the second user is a silent call.

15. The communication system of claim 1, wherein:
the speech system associated with the first user is further configured to receive an audio signal of the speech of the first user when the first user is speaking; and
the one or more processors are further configured to determine the speech data representing the speech of the first user by using a machine learning model to remove noise in the audio signal of the speech of the first user based on the signal indicative of the speech muscle activation patterns of the first user when the first user is speaking.

16. The communication system of claim 15, wherein the one or more processors are further configured to change on or more attributes of a voice of the speech data.

17. The communication system of claim 1, wherein:
the speech data representing the speech of the first user is first speech data representing the speech of the first user;
the communication interface is configured to:
communicate with the communication device associated with a second user on the communication network when the first user is on a first call; and
communicate with a communication device associated with a third user on the communication network when the first user is on a second call;
and wherein the one or more processors are further configured:
to determine second speech data of the speech of the first user when the first user is speaking on the second call; and
transmit the second speech data to the communication device associated with the third user on the communication network using the communication interface.

18. The communication system of claim 17, wherein:
the speech system associated with the first user is further configured to receive an audio signal of the speech of the first user when the first user is speaking;
the signal indicative of the speech muscle activation patterns of the first user is a first signal indicative of the speech muscle activation patterns first user; and
the second speech data is determined at least in part based on a second signal indicative of the speech muscle activation patterns of the first user when the first user is speaking and/or the audio signal of speech of the first user when the first user is speaking.

19. A method for making and receiving a call in a communication system, the method comprising, by one or more processors:
determining speech data representing speech of the first user based on a signal indicative of speech muscle activation patterns of the first user when the first user is speaking;
transmitting the speech data representing the speech of the first user to a communication device associated with a second user on a communication network using a communication interface;
receiving speech data representing speech of the second user from the communication device associated with the second user on the communication network using the communication interface; and
outputting audio of the speech of the second user based on the received speech data representing the speech of the second user.

20. A non-transitory computer readable medium containing program instructions that, when executed, cause one or more processors to:
determine speech data representing speech of the first user based on a signal indicative of a speech muscle activation patterns of the first user when the first user is speaking silently;
transmit the speech data representing the speech of the first user to a communication device associated with a second user on a communication network using a communication interface;
receive speech data representing speech of the second user from the communication device associated with the second user on the communication network using the communication interface; and
output audio of the speech of the second user based on the received speech data representing the speech of the second user.
